(19) United States
(12) Patent Application Publication
(10) Pub. No.: US 2025/0230946 A1
(43) Pub. Date: Jul. 17, 2025

(54) DUAL SOURCE HEAT PUMP SYSTEM WITH MUTUAL DUCT

(71) Applicant: Schlumberger Technology Corporation, Sugar Land, TX (US)

(72) Inventors: Olivier Lecoq, Clamart (FR); Matthieu Simon, Clamart (FR)

(21) Appl. No.: 19/029,345

(22) Filed: Jan. 17, 2025

Related U.S. Application Data
(60) Provisional application No. 63/621,599, filed on Jan. 17, 2024.

(51) Int. Cl. F24F 11/81; F24F 5/00; F24F 11/65; F24F 110/10

(52) U.S. Cl. CPC F24F 11/81; F24F 5/005; F24F 11/65; F24F 2110/10

(57) ABSTRACT

A thermal system includes a first facility fluid circuit including a facility fluid for circulating through a facility, a first facility heat exchanger, and a first facility supply inlet for providing the facility fluid to the facility. A second facility fluid circuit includes the facility fluid, a second facility fluid heat exchanger, and a second facility supply inlet. A ground-source heat pump includes the first facility heat exchanger and is associated with the first facility fluid circuit. An air-source heat pump includes the second facility heat exchanger and is associated with the second facility heat exchanger. A mutual supply duct connects the first and second facility fluid circuits such that the first facility fluid circuit is fluidly connected to the second facility supply inlet and the second facility fluid circuit is connected to the first facility supply inlet.

### CROSS REFERENCE TO RELATED APPLICATIONS

This application claims priority and the benefit of U.S. Patent Application No. 63/621,599, filed on Jan. 17, 2024, which is hereby incorporated by reference in its entirety.

### BACKGROUND OF THE DISCLOSURE

It is becoming ever more important to limit the emission of carbon dioxide, for example, in view of climate change. One particular approach has often been the efficient and renewable use of energy resources for human activities. For instance, heating and cooling systems for buildings and other facilities, whether industrial, commercial, or residential, may typically use a substantial amount of energy. Accordingly, optimizing heating and cooling systems to operate more efficiently and with renewable energy resources may be advantageous.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 illustrates an example of a thermal system for providing heating and/or cooling to a facility, according to at least one embodiment of the present disclosure;

FIG. 2-1 illustrates and example schematic diagram of a ground-source heat pump, according to at least one embodiment of the present disclosure;

FIG. 2-2 illustrates and example of an air-source heat pump, according to at least one embodiment of the present disclosure;

FIGS. 2-3 and 2-4 illustrate schematic diagrams of a thermal system for thermally conditioning a facility, according to at least one embodiment of the present disclosure;

FIGS. 2-5 through 2-22 illustrate various operating modes of the thermal system of FIGS. 2-3 and 2-4, according to at least one embodiment of the present disclosure;

FIG. 3 illustrates a schematic diagram of a thermal system, according to at least one embodiment of the present disclosure;

FIG. 4 illustrates a schematic diagram of a thermal system, according to at least one embodiment of the present disclosure; and

FIG. 5 illustrates a schematic diagram of a thermal system, according to at least one embodiment of the present disclosure.

### DETAILED DESCRIPTION

This disclosure generally relates to a heating and/or cooling thermal system with heat pump systems connected to two different sources, such as air and a geological formation. For example, the thermal system includes an air-source heat pump (ASHP) system for exchanging heat with an ambient air, as well as a ground-source heat pump (GSHP) system for exchanging heat with a geological formation through an open- or closed-loop system like a borehole heat exchanger. In some cases, these two heat pump systems are each contained within separate enclosures, which each may be positioned on a roof of a facility as separate, contained rooftop units. For example, each heat pump system may be connected to a roof curb as are conventionally used in facility HVAC systems. The thermal system may be operated based on one or both of the heat pump systems to provide thermal conditioning to the facility. For instance, a facility fluid may circulate through a facility for providing thermal conditioning to the facility, and the facility fluid may exchange heat with one or more of the ASHP system and the GSHP system.

The roof curbs to which the respective enclosures are connected may, in some cases, be connected to ductwork that each serves specific and/or isolated spaces of a facility. A typical rooftop unit may operate independently to condition the associated space.

The thermal systems of the present disclosure include a mutual supply duct and/or a mutual return duct that may facilitate fluidly connecting the rooftop units (e.g., the different heat pump systems) such that either (or both) heat pump systems may be utilized to provide conditioned air to many different spaces within a building, including those to which they are not directly connected (e.g., not directly connected to a roof curb for a respective interior space). Thus, by dynamically connecting together two or more rooftop units (i.e., having different heat pump sources), which each may be connected to one or more isolated space of the facility, the heat pump sources may be utilized in various different proportions and configurations.

By utilizing two or more different thermal sources (e.g., the air and the ground) in this way, and by selectively implementing each heat pump system as needed, the thermal systems described herein may operate at considerable efficiency. For example, the thermal system may implement, or more heavily utilize, the heat pump system having the source that has the most favorable operating conditions (e.g., temperatures) at a given time, leading to efficiency gains. The thermal systems described herein may also be housed, packaged, or otherwise contained within two or more enclosures, modules, or units, for example, for transporting to a facility and implementing (e.g., positioning) at or on the facility. By implementing a thermal system in this way (e.g., thermal units), the thermal system may be seamlessly employed at a facility in conjunction with typical equipment and componentry (e.g., ductwork, roof curbs) of a facility, including retrofitting existing equipment, while realizing efficiency gains. Indeed, by implementing the mutual ductwork as described herein in connection with (e.g., single-zone) roof curbs and ductwork of typical rooftop units, the present techniques may advantageously service many interior spaces in a more energy-efficient manner.

Such a packaged, thermal unit may include all of the fluid circuits and working fluids (and/or couplings for connecting to associated fluid circuits), pumps, valves, sensors, controllers (e.g., processor), etc., for implementing the thermal system and meeting the thermal needs of a facility as one centralized, integrated system. For instance, the thermal system may integrate multiple sensors for taking relevant measurements. For example, the thermal system may measure energy fluxes to and/or from the ground such as through inlet temperatures, outlet temperatures, and flowrates of a downhole fluid through a borehole heat exchanger. The thermal system may measure energy fluxes to and/or from the air, as well as to and/or from the facility, by measuring, for example, the supply air temperature, the return air temperature, and air flow rates. The thermal system may measure the electricity consumption of the various components such as compressors, fans and/or circulation pumps. Based on these sensor measurements, the thermal system may determine a system efficiency, such as coefficients of performance for the air and ground heat pump subsystems.

The thermal system may leverage this information and more to calibrate digital models of the thermal system, in order to identify and implement an efficient control strategy. For example, the system efficiency may be optimized, based on shifting and/or leveraging and selectively implementing the air energy source and/or ground energy source based on the current operating conditions (e.g., temperatures) of the sources to transfer thermal energy in an efficient manner. For example, the various components, heat pumps, fluid circuits, etc. of the thermal system described herein may be selectively operated and/or modulated in connection with a control strategy to increase the efficiency of compressor and/or circulation pump usage, leverage sources of thermal energy in an advantageous way, and to manage the temperature of the ground thermal battery in the short and long term (e.g., over the course of a year as well as over the course of a regulatory period, such as 25 or 50 years). In this way, the thermal system may be controlled to meet various objectives, such as efficiency objectives, while meeting the thermal needs (both current and forecasted) of the facility. The thermal system may also leverage sensor data and other measurements, coupled with the digital models, to estimate the health of the thermal system, including predicting potential failures before they arise, or predicting a need for maintenance.

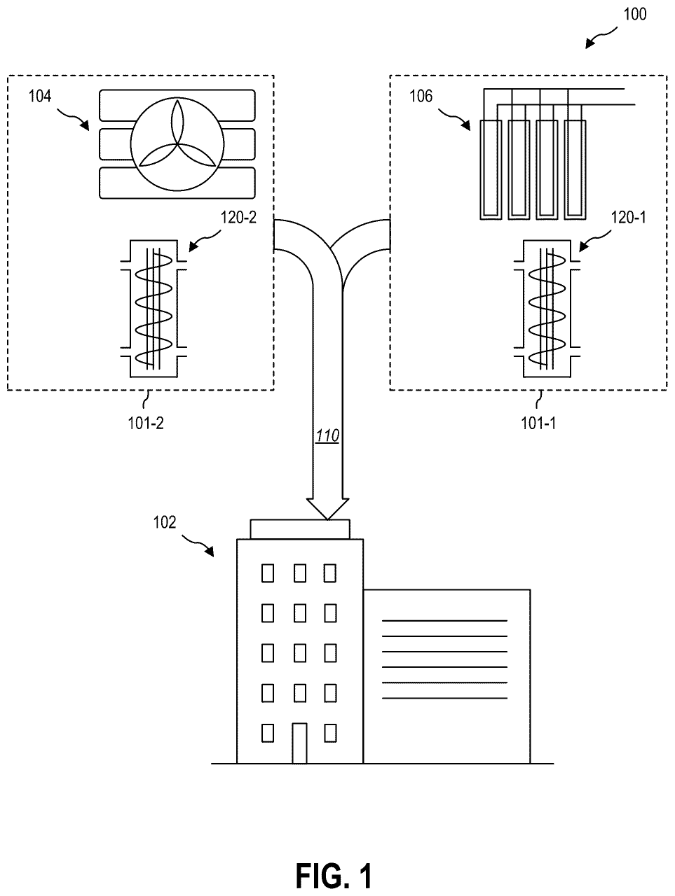

Turning now to FIG. 1, this figure illustrates an example of a thermal system 100 for providing heating and/or cooling to a facility 102. The thermal system 100 is in thermal communication with the facility 102 via a flow of a facility fluid 110, which may be a gaseous thermal fluid such as air or may be a liquid thermal fluid such as water, glycol, etc. The facility 102 may be any structure, building, area, or space that may have one or more thermal loads, or which may require thermal conditioning, such as in the form of heating, cooling, hot water, cold water, etc. For instance, the facility 102 may be a building, group or campus of several buildings, a warehouse, etc.

The thermal system 100 may be a dual-source thermal system. For example, the thermal system 100 may include a dual-source heat pump system, which may have one or more heat pump circuits that are configured to exchange heat with one or more sources. For example, the thermal system 100 may include an air-source heat pump (ASHP) system 104 for exchanging heat or calories with an air source, such as with ambient air and/or exhaust air exhausted from the building. The thermal system 100 may include a ground-source heat pump (GSHP) system 106 for exchanging heat or calories with a ground source, such as a geological formation (e.g., including any underground source which may include underground air, water, or other fluids) through a borehole heat exchanger and via a downhole fluid circuit. The GSHP system 106 may include a first facility heat exchanger 120-1 for transferring heat to and/or from the facility fluid 110 through the first facility heat exchanger 120-1. The ASHP system 104 may include a second facility heat exchanger 120-2 for transferring heat to and/or from the facility fluid 110 through the second facility heat exchanger 120-2. In this way, thermal conditioning of the facility 102 may be provided via the facility fluid 110 from one or both of the GSHP system 106 and the ASHP system 104. For example, as described herein, the GSHP system 106 and the ASHP system 104 may be connected by one or more mutual ducts, such as a mutual supply duct and/or a mutual return duct in order control an amount of flow to and/or from each of the GSHP 106 and ASHP 104, such that proportionate amounts of the facility fluid 110 may be circulated through and conditioned by the GSHP system 106 and the ASHP system 104, respectively, in order to provide efficient and effective thermal conditioning of the facility 102.

In this way, thermal conditioning of the facility 102 may be facilitated through the thermal system 100. For example, the GSHP system 106 and the ASHP system 104 may each be implemented to provide heating and/or cooling via the first facility heat exchanger 120-1 and the second facility heat exchanger 120-2, respectively. Each heat pump system may be operated at independent thermal capacities in order to provide thermal conditioning to satisfy thermal loads at an increased efficiency, for example, based on advantageously leveraging the operating conditions of a given source. In this way, the thermal system 100 may provide improvements to the efficiency, operating cost, carbon emissions, etc. of providing heat and/or cooling (e.g., thermal conditioning to satisfy thermal needs as described herein) to the facility 102.

The thermal system 100 may also be implemented as one or more packaged, plug-and-play thermal systems (e.g., thermal units) for implementing at or on the facility 102. For example, as described herein, one or more (or all) of the components of the GSHP system 106 and/or the ASHP system 104 may be contained within respective enclosures 101-1 and 101-2, which may facilitate transporting the thermal system 100 to the facility 102, and positioning, implementing, connecting, maintaining, and operating the thermal system 100 for providing thermal conditioning to satisfy various thermal loads of the facility 102. For instance, the thermal system 100 may be implemented as plug-and-play modules or units, which may be implemented on a roof of the facility, within the facility, etc. In this way, the thermal system 100 may be implemented to replace or forego the need for an onsite technical or mechanical room for implementing, managing, operating, etc. multiple different thermal systems associated with multiple different thermal needs of the facility 102. In some cases, the GSHP system 106 and the ASHP system 104 contained within the enclosures 101-1 and 101-2 may be implemented in connection with an existing opening, hole, or roof curb of the facility 102, for example, to facilitate implementing the thermal system 100 in connection with an existing (e.g., or conventional) ductwork or HVAC components of the facility 102. For instance, in some embodiments the thermal system 100 may be implemented to cover and/or replace other thermal equipment for providing heating and/or cooling to the facility 102 (e.g., hot and/or cool air). The thermal system 100 may accordingly provide a reduction in the capital expense of the facility 102, by providing improved overall performance of heating and/or cooling of the facility 102, such as by increasing the usage of renewable energy at the facility.

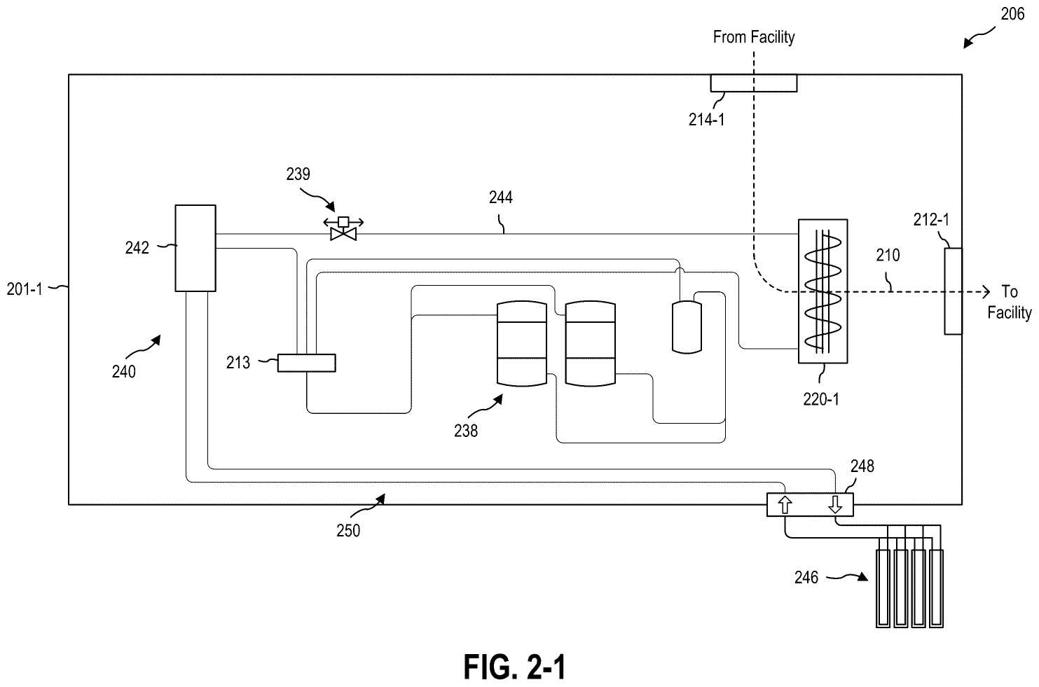

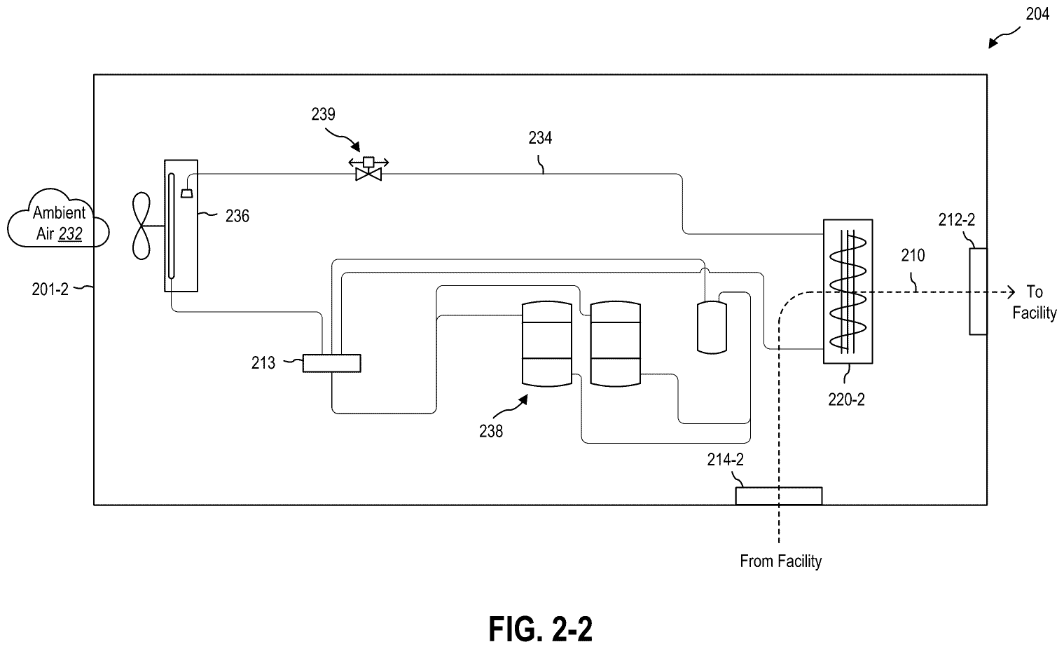

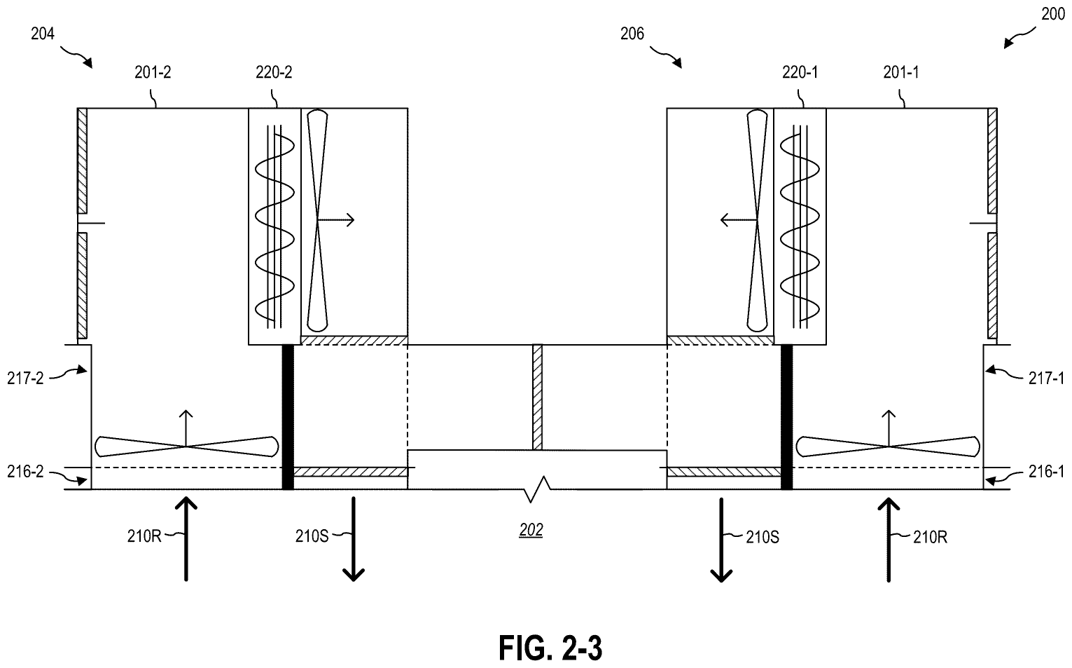

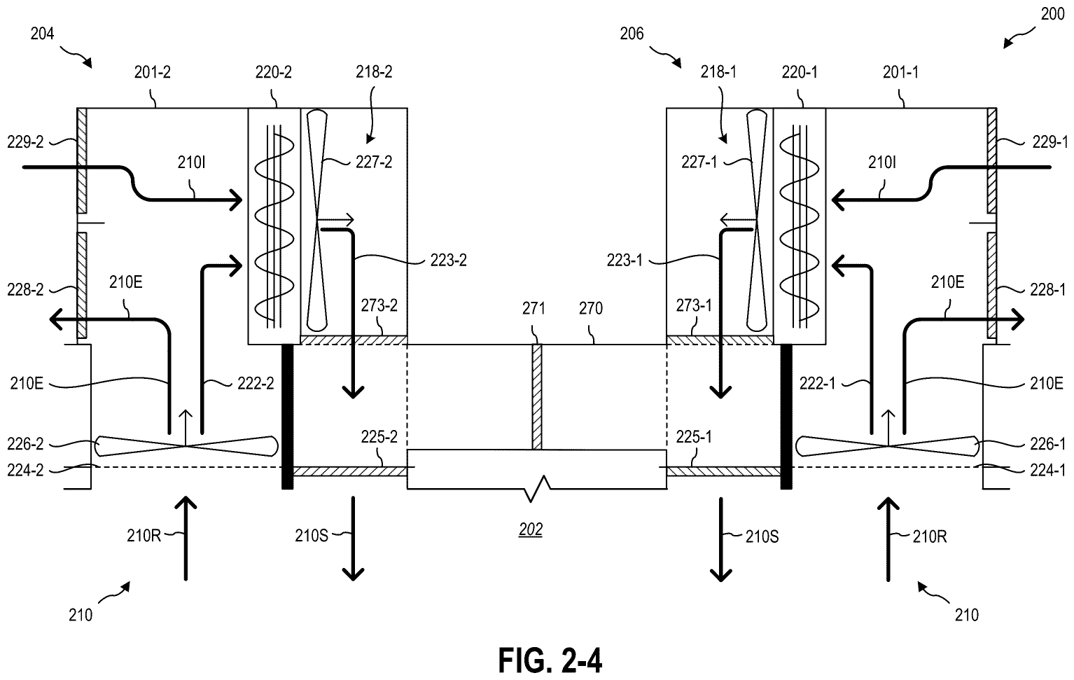

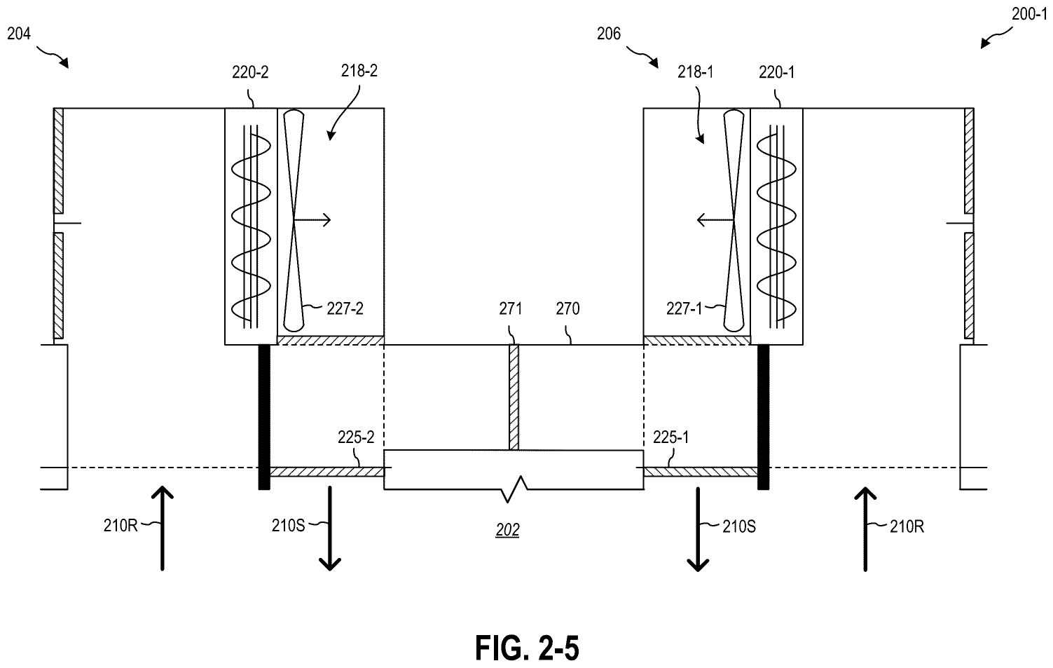

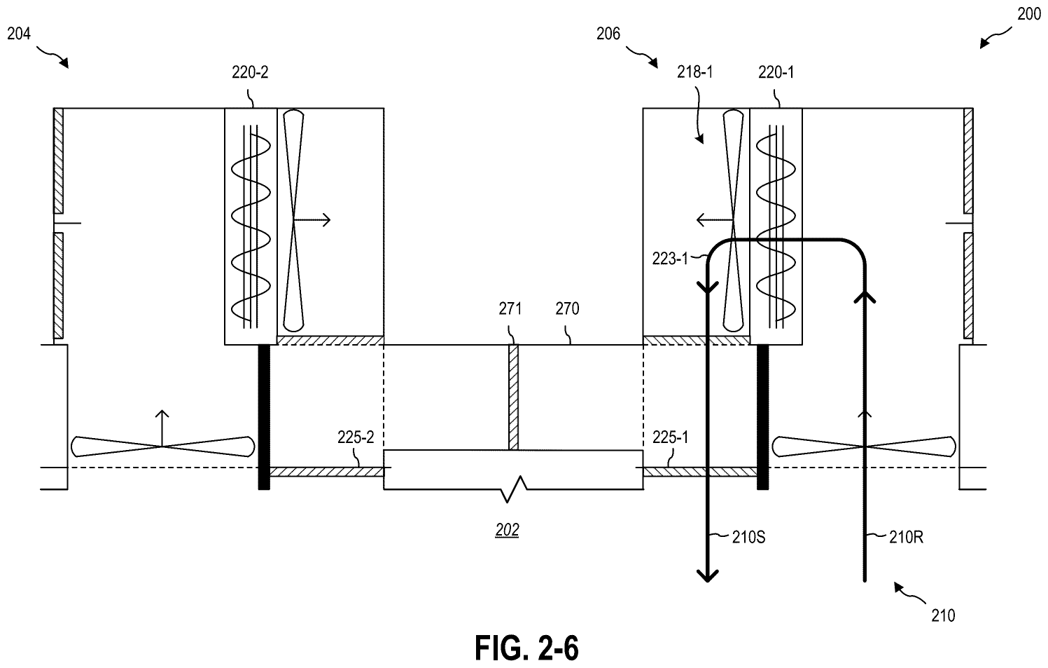

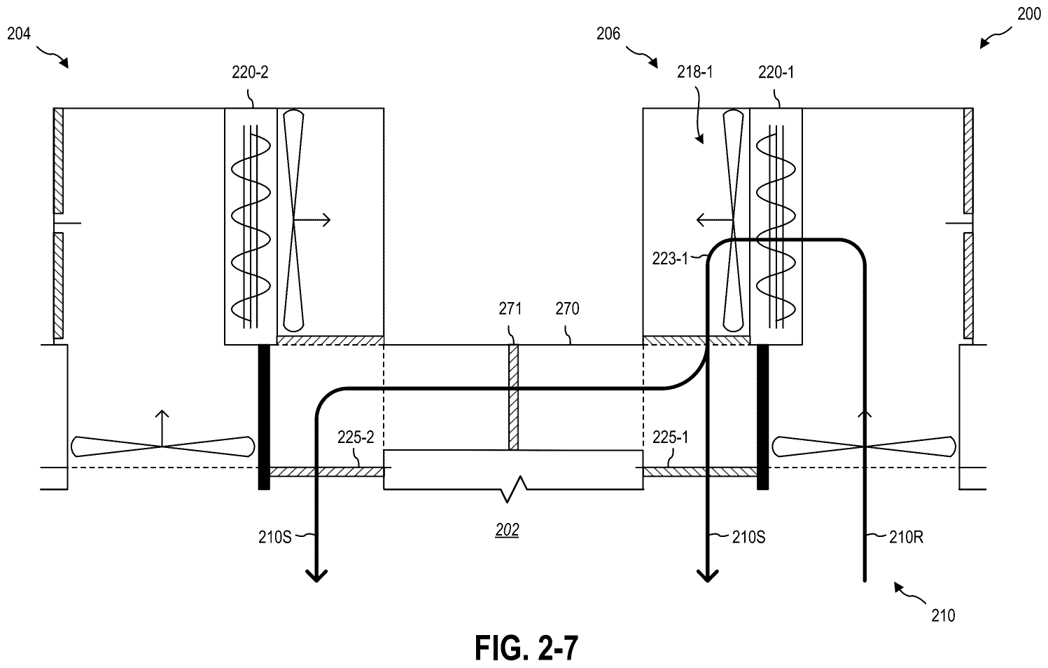

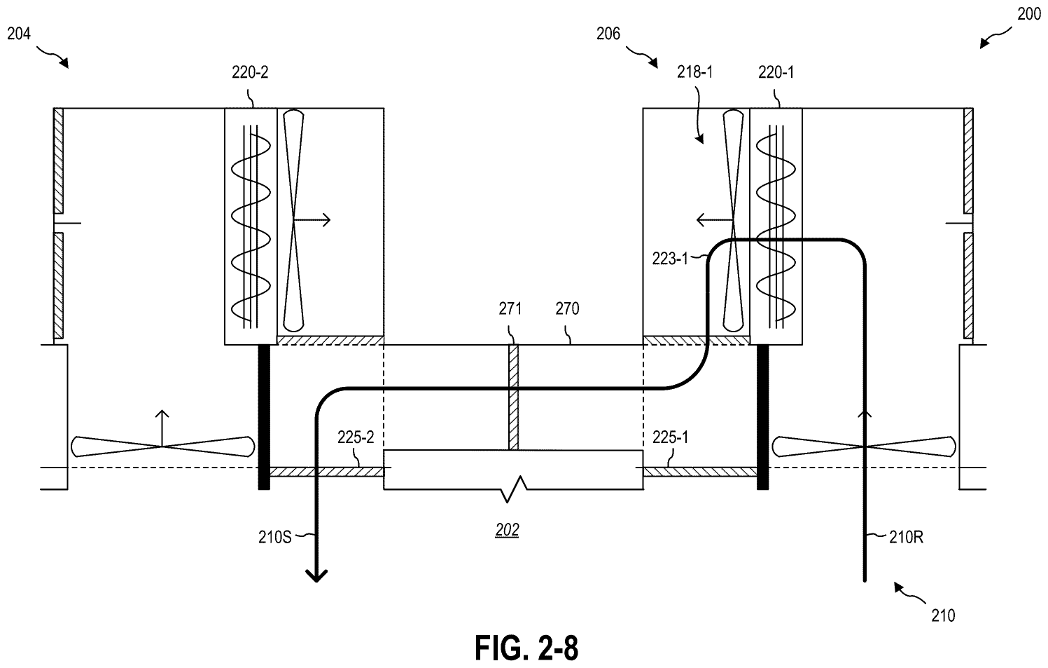

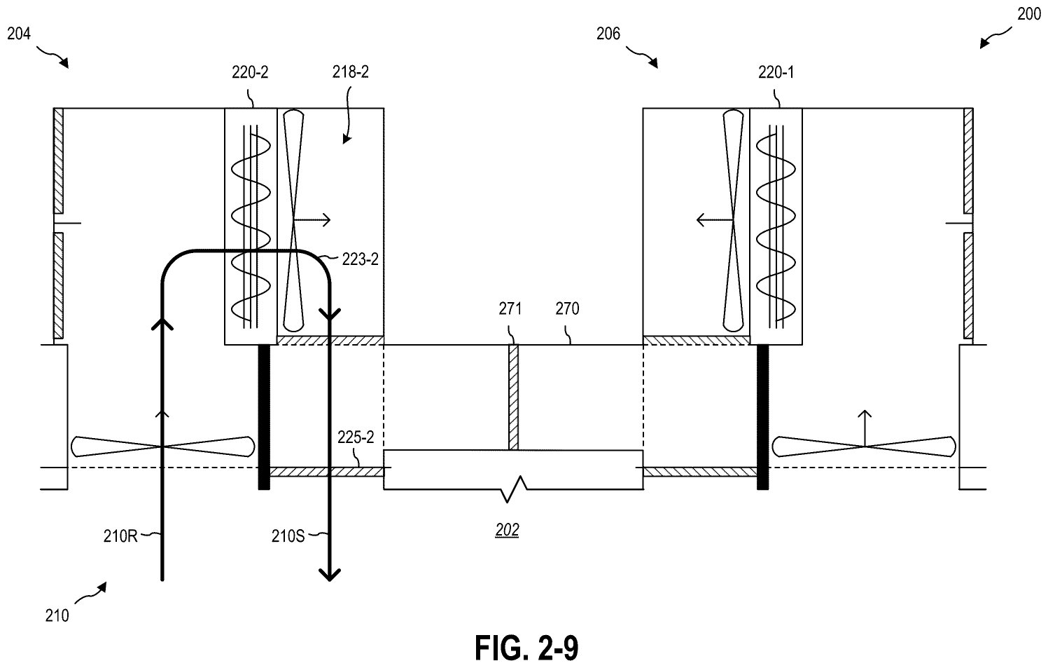

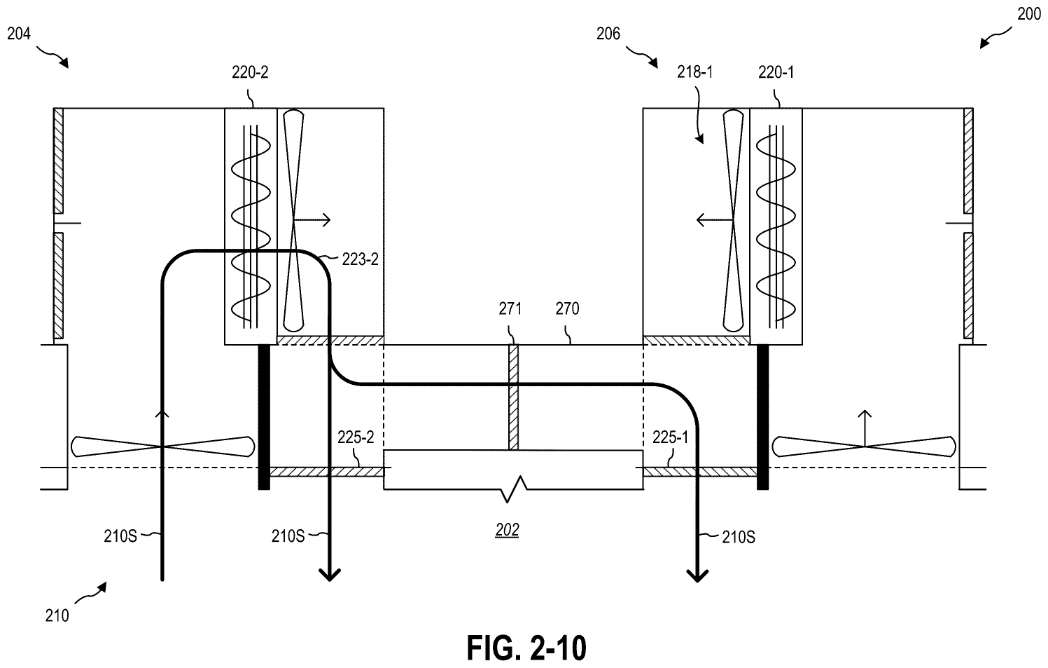

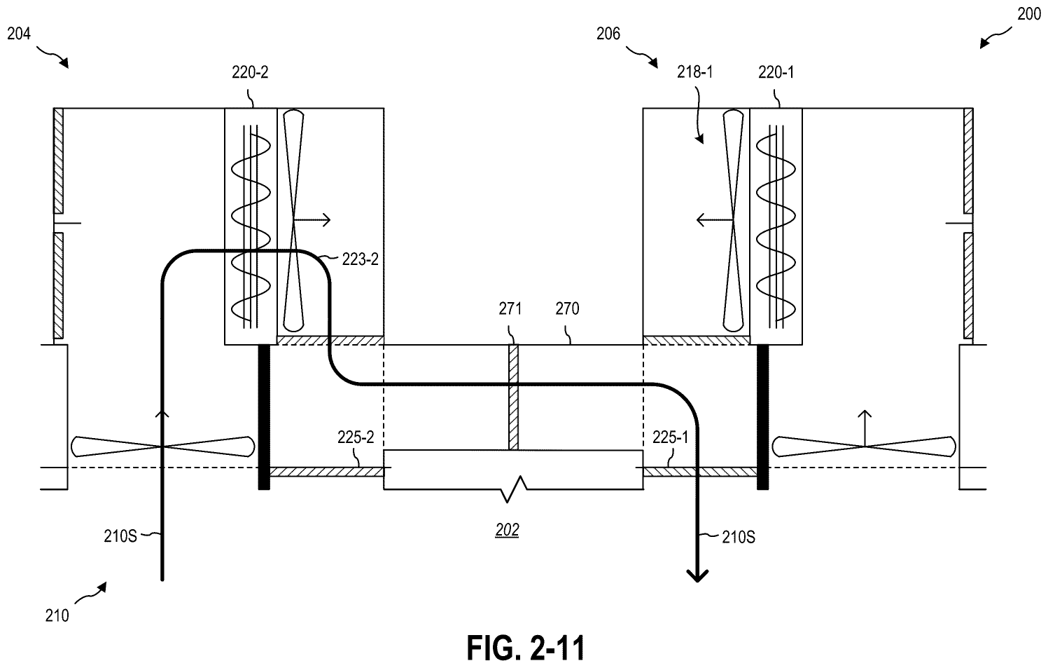

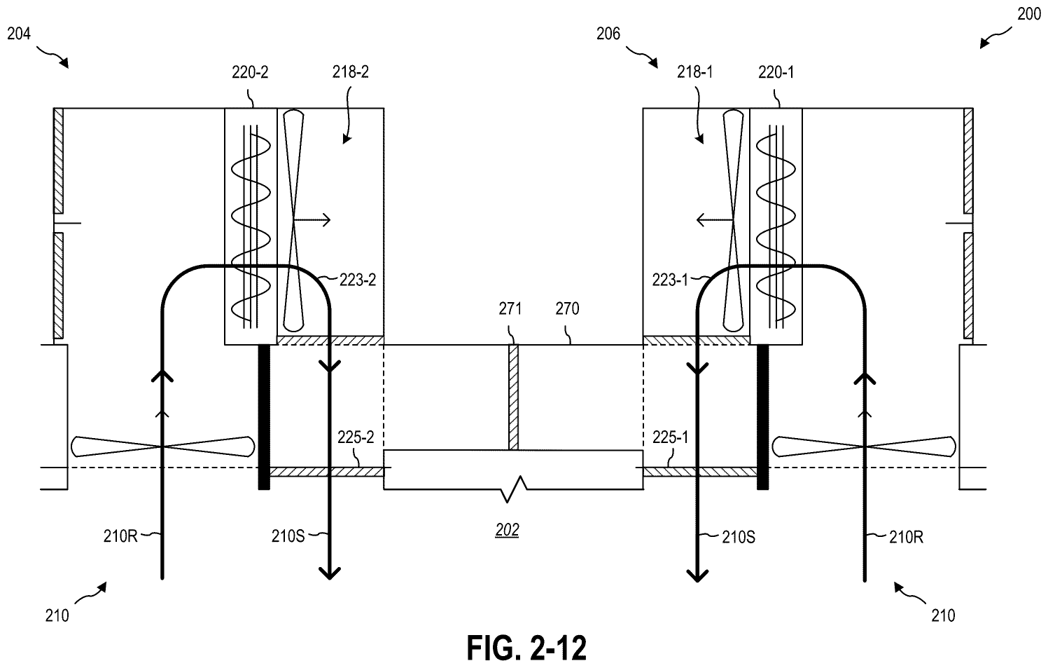

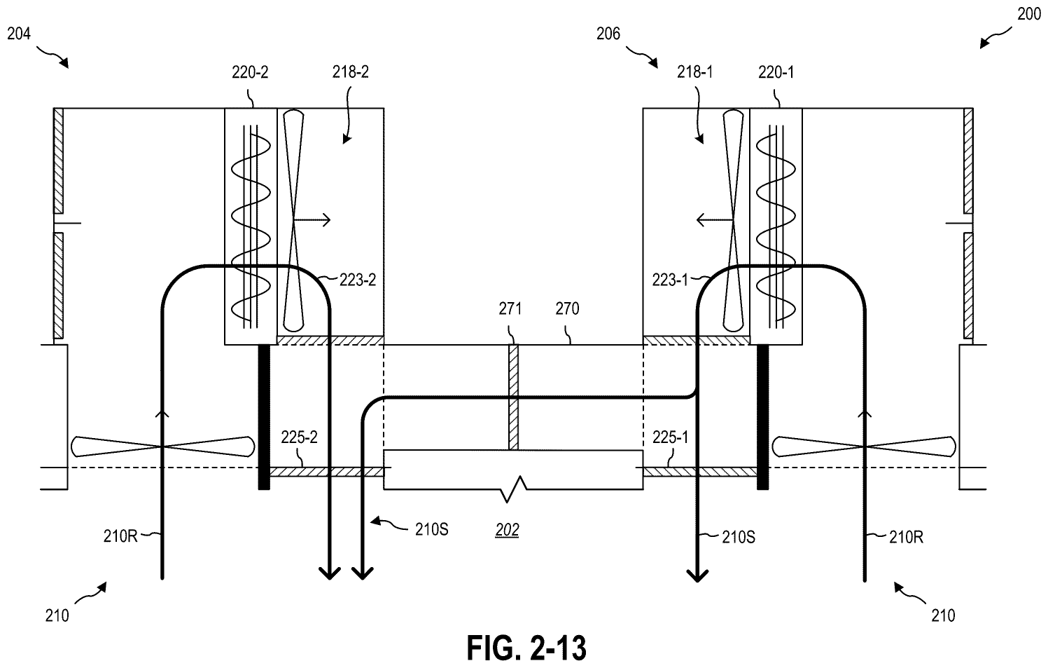

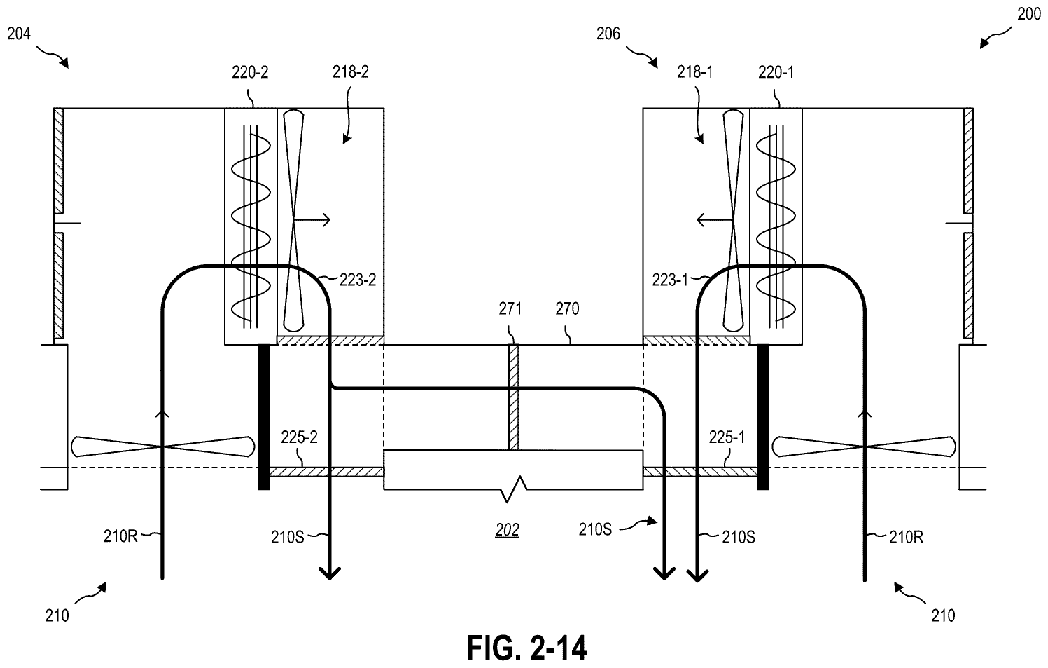

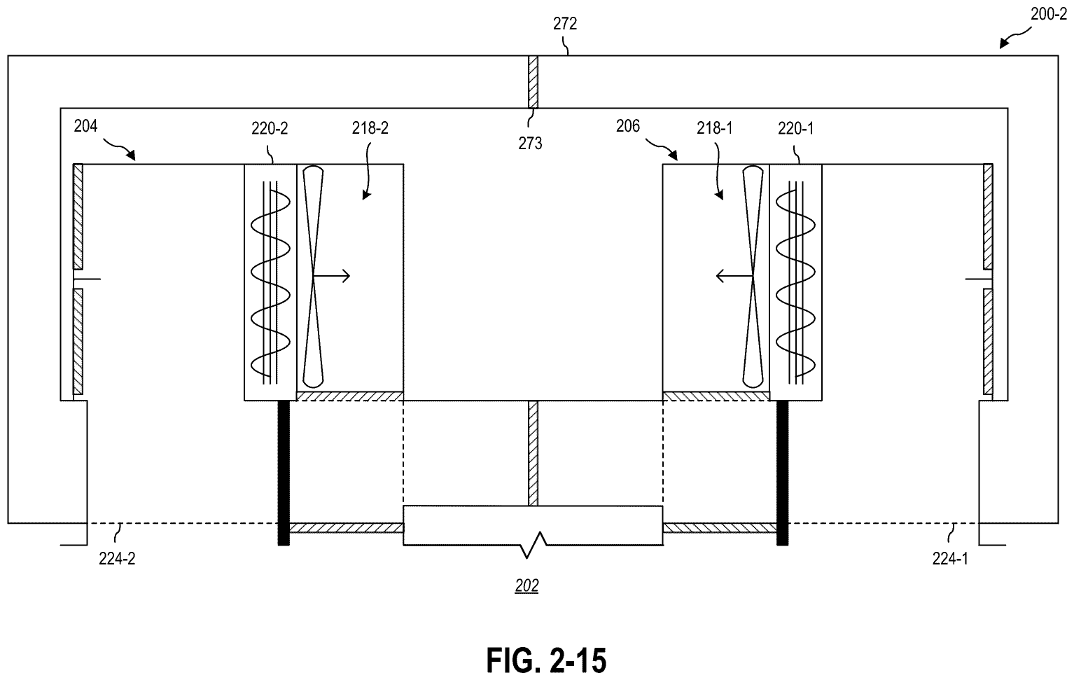

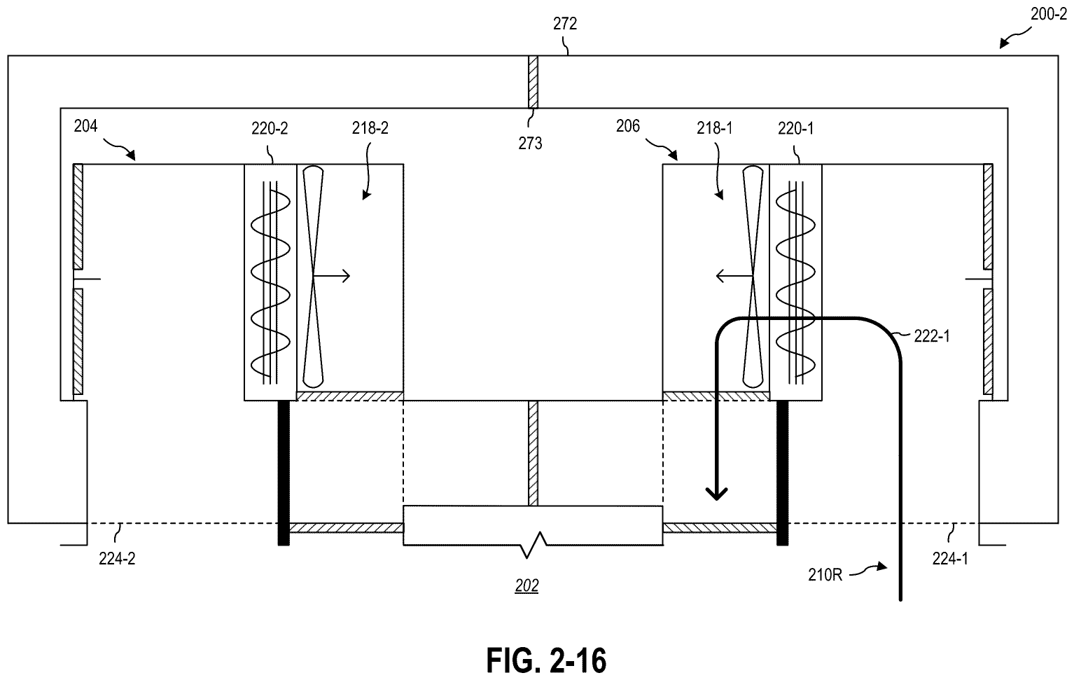

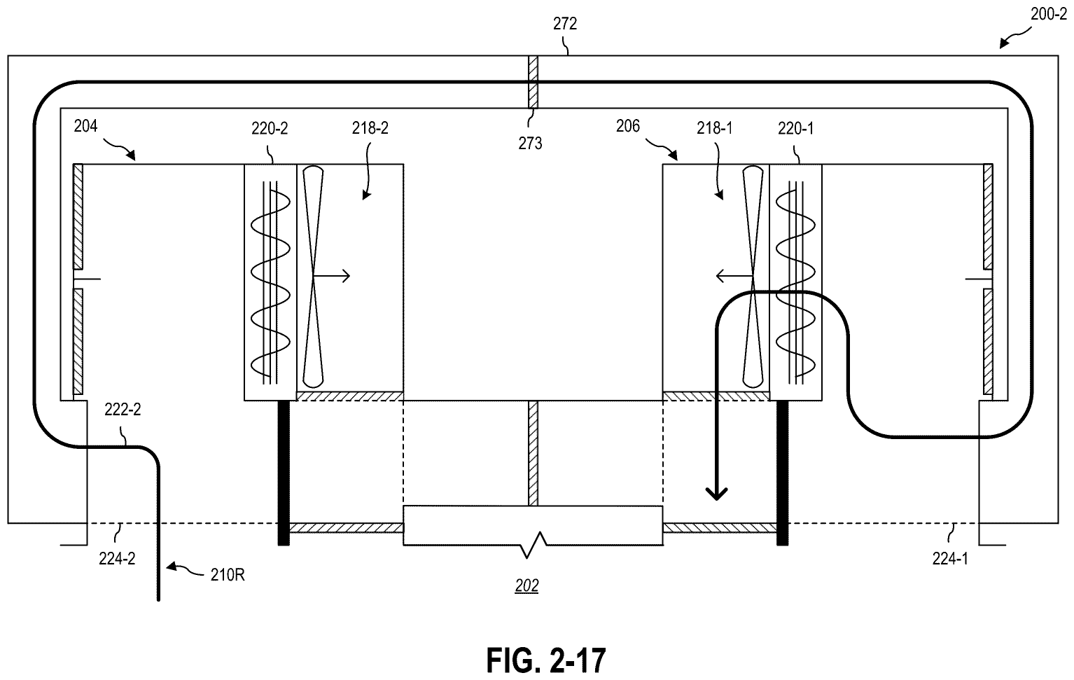

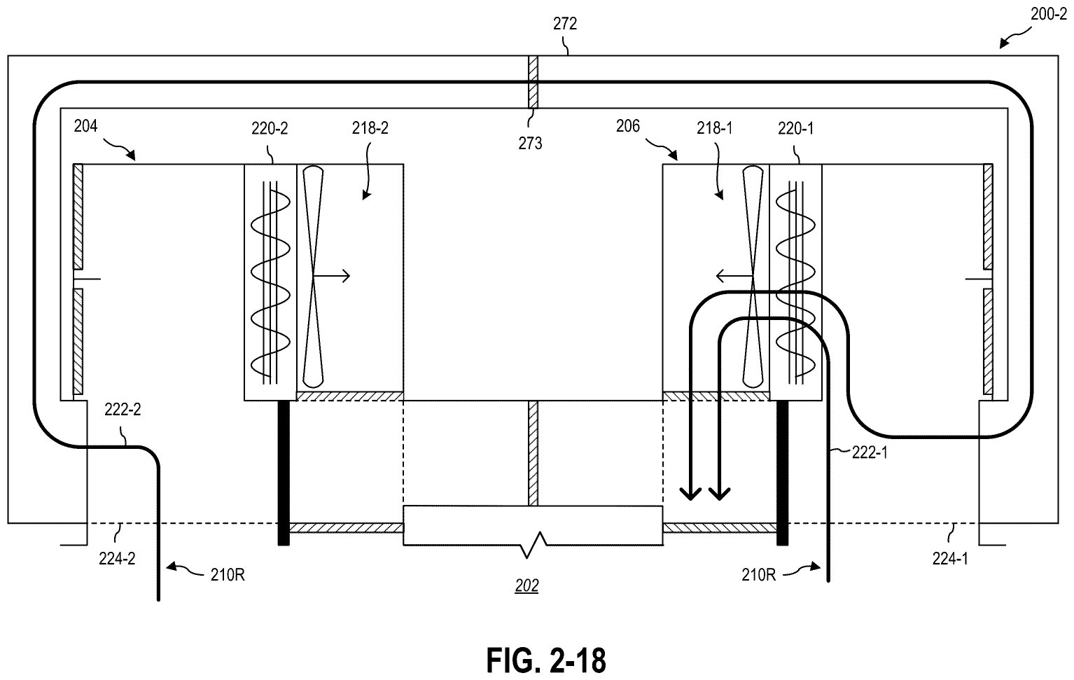

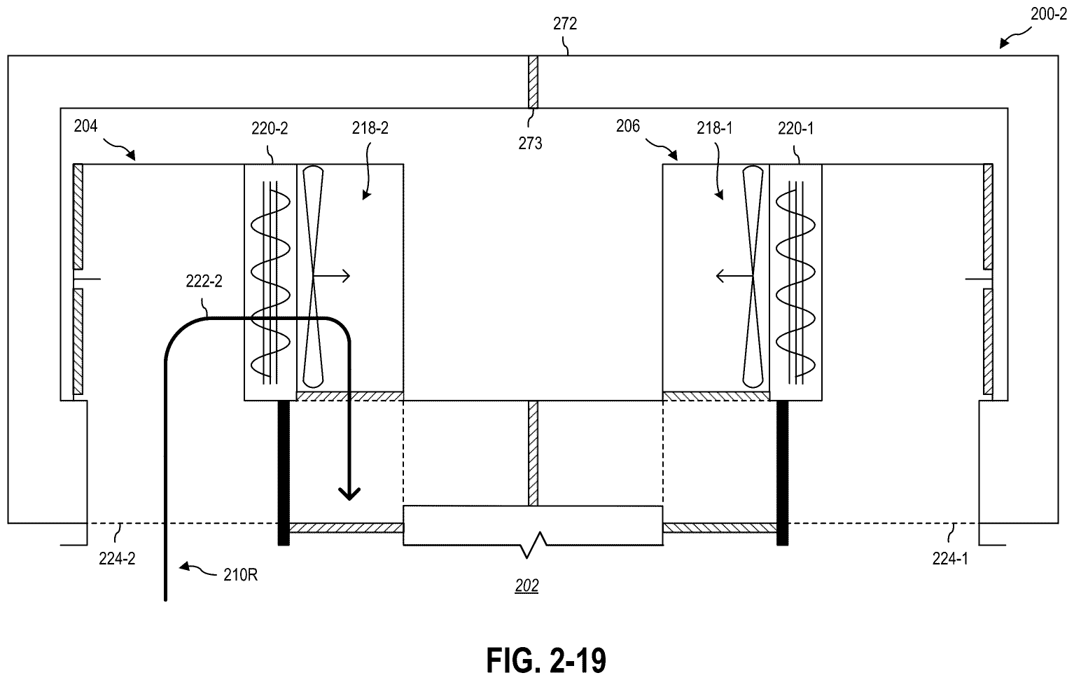

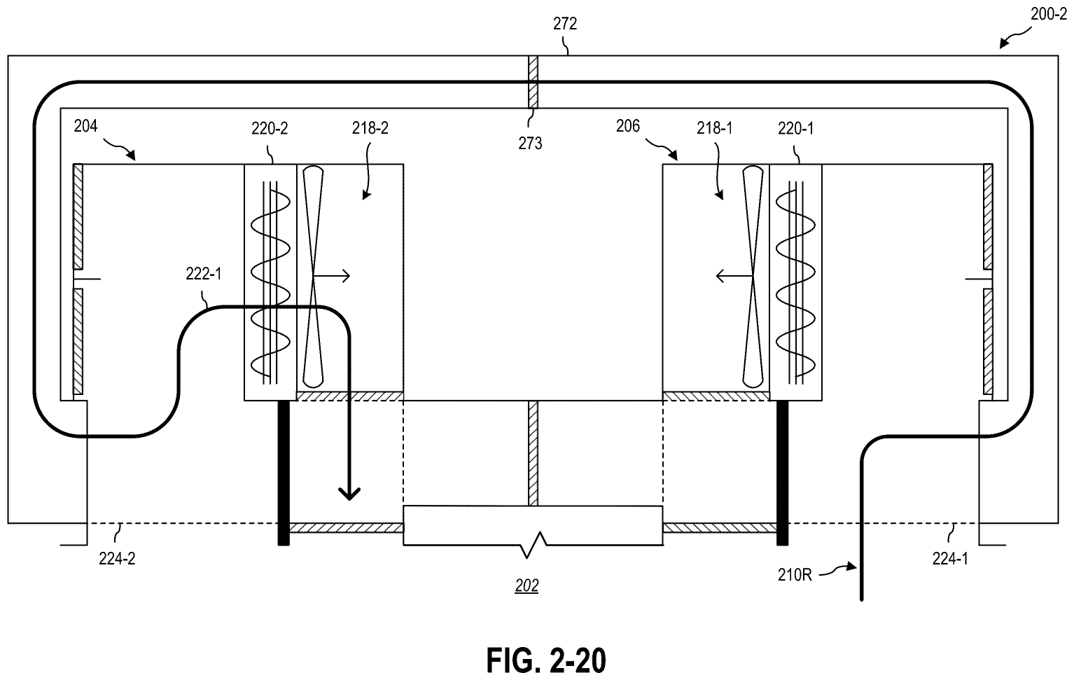

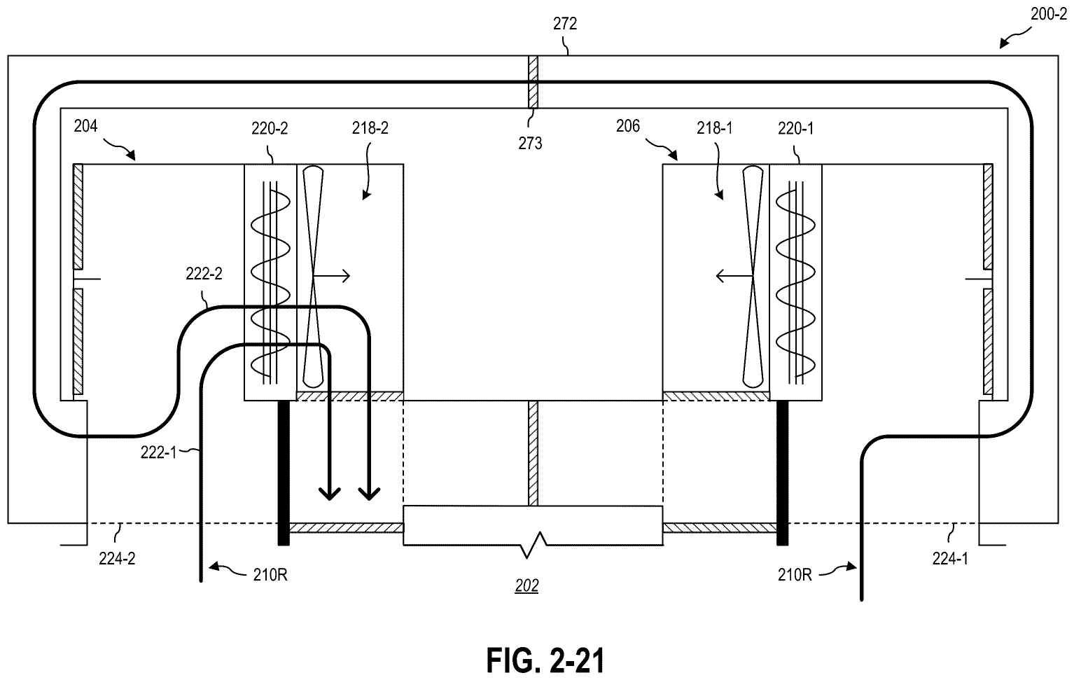

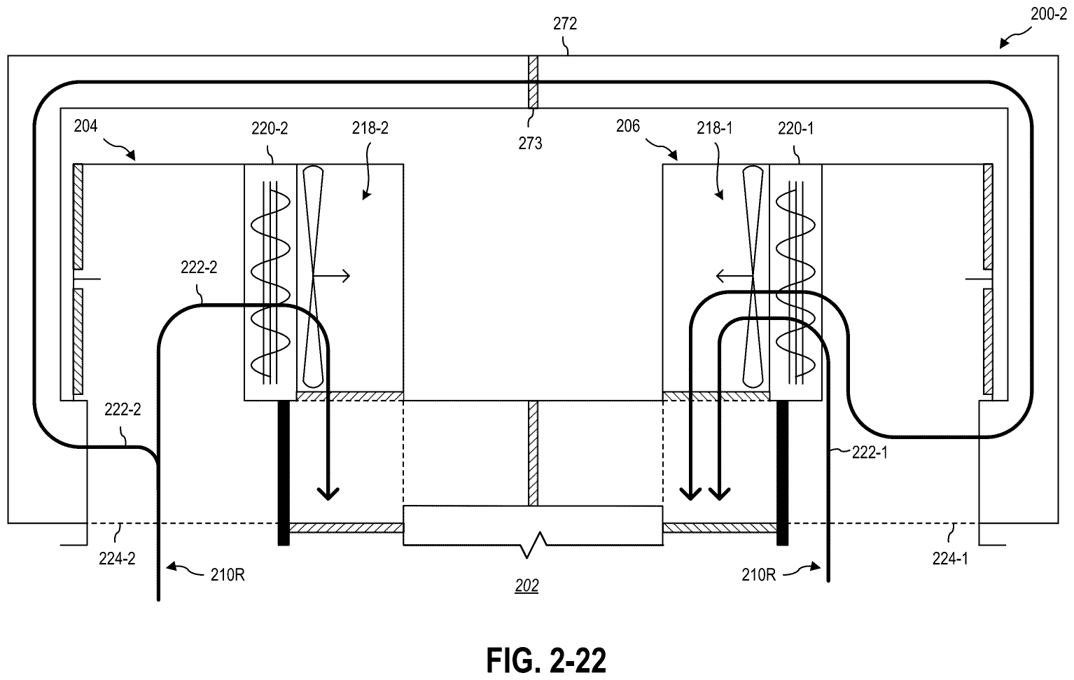

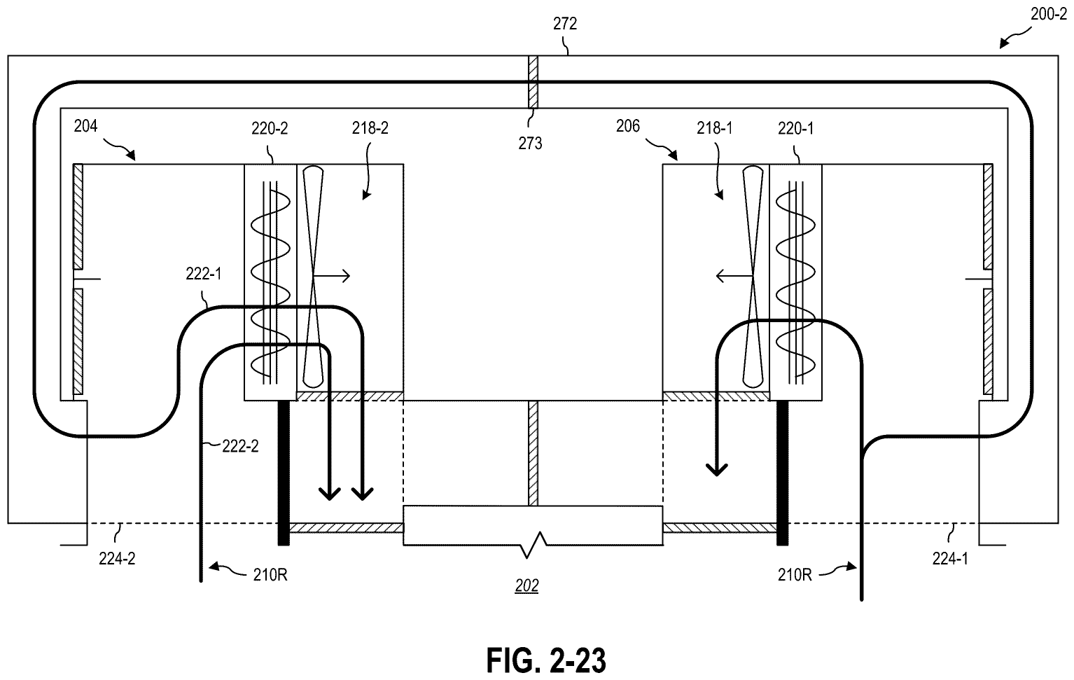

FIG. 2-1 illustrates an example schematic diagram of a GSHP 206, according to at least one embodiment of the present disclosure. In some cases, some or all of the components of the GSHP 206 may be included on, within, or at an enclosure 201-1. The GSHP 206 may be implemented for providing heating and/or cooling to a facility via a flow of a facility fluid 210. For example, the GSHP 206 may include one or more fluid pumps (e.g., fans) for flowing the facility fluid 210 through the GSHP 206 and/or through the facility. The facility fluid 210 may be air which may circulate within the facility to provide thermal conditioning to the facility. For instance, the GSHP 206 may include and/or may be associated with a first facility supply inlet 212-1 through which the facility fluid 210 may flow from the GSHP 206 to the facility, and may include (or be associated with) a first facility return inlet 214-1 through which the facility fluid 210 may flow from the facility to the GSHP 206. The first facility supply inlet 212-1 and/or the first facility return inlet 214-1 may implemented within or on the enclosure 201-1, or else may be implemented as one or more additional components as described herein for facilitating exchanging the facility fluid 210 with the facility.

The GSHP 206 includes a ground-source heat exchanger 242. The ground-source heat exchanger 242 may be a heat exchanger (e.g., liquid-to-liquid) of any suitable type for facilitating the exchange of heat with a downhole fluid of a downhole fluid circuit 250. For example, the ground-source heat exchanger 242 may facilitate exchanging heat between a ground-source working fluid and the downhole fluid of the downhole fluid circuit 250.

The GSHP 206 may be implemented via a GSHP fluid circuit 244. The GSHP fluid circuit 244 includes a system of pipes, tubes, channels, lines, etc., through which a ground-source working fluid may be circulated. For example, the ground-source working fluid may be a coolant, refrigerant, thermal fluid, or any other suitable fluid for implementing the heat pump techniques of the GSHP 206. The GSHP 206 also includes one or more compressors 238 and one or more expansion valves 239 positioned on the GSHP fluid circuit 244. The GSHP fluid circuit 244 may include one or more fluid distribution devices for directing the ground-source working fluid, for example, between the ground-source heat exchanger 242 and a first facility heat exchanger 220-1. In this way, the GSHP 206 may implement a refrigerant cycle for transferring heat at the first facility heat exchanger 220-1 and at the ground-source heat exchanger 242 based on performing mechanical work on (e.g., compressing and/or expanding) the ground-source working fluid. The GSHP 206 may include one or more pumps and/or valves for directing the flow of the ground-source working fluid through various fluid paths and with respect to various operating modes as described herein. For example, the GSHP 206 may include a variable valve 213 which may operate to activate and/or connect various combinations of lines or flow paths in order to facilitate directing the flow of the ground-source working fluid in accordance with one or more different operating modes (e.g., heating and/or cooling). In some embodiments, the GSHP 206 includes one or more decoupling tanks or buffer tanks.

The downhole fluid circuit 250 may be a fluid circuit for facilitating exchanging heat between the GSHP 206 and a geological formation or other underground thermal source. For example, the downhole fluid may flow through the downhole fluid circuit 250 and may flow between the ground-source heat exchanger 242 and a borehole heat exchanger 246. The borehole heat exchanger 246 may include one or more boreholes of a borefield through which a downhole fluid may flow in order to exchange heat with the geological formation. The borehole heat exchanger 246 may be situated at, near, in the neighborhood of, or otherwise in association with the facility. The downhole fluid may be water, glycol, a mixture thereof, or any other appropriate thermal fluid.

The GSHP 206 may include a portion of the downhole fluid circuit 250. For example, one or more lines, flow paths, pipes, etc., of the downhole fluid circuit 250 may be included as part of the GSHP 206 and/or the enclosure 201-1. The thermal system 200 may include a downhole coupling 248 for facilitating the connection of the portion of the downhole fluid circuit included in the thermal system with the remainder of the downhole fluid circuit, including connecting to the borehole heat exchanger 246. In this way, in some cases, the borehole heat exchanger 246 may be external to, or may not be considered as part of or included in the GSHP 206. For instance, as described herein, some or all of the GSHP 206 may be included within an enclosure 201-1, module, or unit, and the borehole heat exchanger 246 may not be included within the enclosure 201-1.

The GSHP 206 includes the first facility heat exchanger 220-1. The first facility heat exchanger 220-1 may be positioned such that the facility fluid 210 flows through the first facility heat exchanger 220-1 to thermally condition the facility fluid 210 before it flows to the facility through the first facility supply inlet 212-1. For instance, the facility fluid 210 may exchange heat with the ground-source working fluid through the first facility heat exchanger 220-1 in order to heat or cool the facility fluid 210.

FIG. 2-2 illustrates an example schematic diagram of an ASHP 204, according to at least one embodiment of the present disclosure. In some cases, some or all of the components of the ASHP 204 may be included on, within, or at an enclosure 201-2. The ASHP 204 may be implemented for providing heating and/or cooling to the facility via a flow of the facility fluid 210. For example, the ASHP 204 may include one or more fluid pumps (e.g., fans) for flowing the facility fluid 210 through the ASHP 204 and/or through the facility. The ASHP 204 may include and/or may be associated with a second facility supply inlet 212-2 through which the facility fluid 210 may flow from the ASHP 204 to the facility, and may include (or be associated with) a second facility return inlet 214-2 through which the facility fluid 210 may flow from the facility to the ASHP 204. The second facility supply inlet 212-2 and/or the second facility return inlet 214-2 may be implemented within or on the enclosure 201-2, or else may be implemented as one or more additional components as described herein for facilitating exchanging the facility fluid 210 with the facility.

The ASHP 204 includes an air-source heat exchanger 236 that is thermally connected to the second facility heat exchanger 220-2 to facilitate exchanging heat between the facility fluid 210 and an ambient air 232. For example, the air-source heat exchanger 236 may include one or more fins, tubes, coils, plates, or any other type of heat exchanger for transferring heat to and/or from the ambient air 232. In some embodiments, the air-source heat exchanger 236 includes or is associated with a fan, pump, or other means for forcing air to facilitate heat transfer. The ASHP 204 may include ductwork or other suitable fluid passage(s) or coupling for providing the ambient air 232 to the air-source heat exchanger 236. For example, the ambient air 232 may be fresh air or outside air captured outside of the enclosure 201-2 and/or exhaust air exhausted from the facility. The ASHP 204 may include one or more dampers, fans, motive devices, etc., for providing the ambient air 232 in this way.

The ASHP 204 is implemented via an ASHP fluid circuit 234. For example, the ASHP fluid circuit 234 may include a system of pipes, tubes, channels, lines, etc., through which an air-source working fluid may be circulated. For instance, the air-source working fluid may be a coolant, refrigerant, thermal fluid, or any other suitable fluid for implementing the heat pump techniques of the ASHP 204. Similar to the GSHP 206, the ASHP 204 includes one or more compressors 238 and one or more expansion valves 239 positioned on the ASHP fluid circuit 234. The ASHP fluid circuit 234 may include one or more fluid distribution devices for directing the air-source working fluid, for example, between the air-source heat exchanger 236 and a second facility heat exchanger 220-2. In this way, the ASHP 204 may implement a refrigerant cycle for transferring heat at the facility heat exchanger 220 and at the air-source heat exchanger 236 based on performing mechanical work (e.g., compressing and/or expanding) the air-source working fluid. The ASHP 204 may include one or more pumps and/or valves for directing the flow of the air-source working fluid through various fluid paths and with respect to various operating modes as described herein. For example, the ASHP 204 may include a variable valve 213 which may operate to activate and/or connect various combinations of lines or flow paths in order to facilitate directing the flow of the ground-source working fluid in accordance with one or more different operating modes (e.g., heating and/or cooling). In some embodiments, the ASHP 204 includes one or more decoupling tanks or buffer tanks.

The ASHP 204 has been represented, in FIG. 2-2, as being connected to ambient air 232 but in other embodiments, it may be connected to one or more other air sources, such as exhaust air exhausting from the facility. In one embodiment, the air-source heat exchanger 236 may be selectively connected to the ambient air 232 and/or the exhaust air depending on the temperature of the source and the facility. For instance, the air-source heat exchanger 236 may be connected to the hottest air sources if in heating mode or the coolest air source if in cooling mode. In another example, the air-source heat exchanger 236 may receive air from both sources, the proportion of flow of air received from each of the sources may be controlled depending on the temperature of the source and the needs of the facility.

The ASHP 204 includes the second facility heat exchanger 220-2. The second facility heat exchanger 220-2 may be positioned such that the facility fluid 210 flows through the second facility heat exchanger 220-2 to thermally condition the facility fluid 210 before it flows to the facility through the second facility supply inlet 212-1. For instance, the facility fluid 210 may exchange heat with the air-source working fluid through the second facility heat exchanger 220-2 in order to heat or cool the facility fluid 210.

The ASHP 204 and the GSHP 206 may each be reversible, or may work in two, reversible directions of a refrigerant cycle. For example, in a first mode or direction, the GSHP 206 and the ASHP 204 may be operated to extract heat from the downhole fluid and ambient air 232, respectively, and transfer the heat to the facility fluid 210. In a second mode or direction, the GSHP 206 and the ASHP 204 may be operated to extract heat from the facility fluid 210 and transfer the heat to the downhole fluid and ambient air 232, respectively. The operating modes may be implemented based on actuating or changing the variable valves 213 of the GSHP 206 and the ASHP 204.

FIGS. 2-3 and 2-4 illustrate schematic diagrams of a thermal system 200 for thermally conditioning a facility 202, according to at least one embodiment of the present disclosure. The thermal system 200 may include both the GSHP 206 and the ASHP 204 as shown and descried in FIGS. 2-1 and 2-2, respectively.

The GSHP 206 may be implemented as shown and described in connection with FIG. 2-1, and the various components may be contained within the enclosure 201-1. Similarly, the ASHP 204 may be implemented as shown and described in connection with FIG. 2-2, and the various components may be contained within the enclosure 201-2. For simplicity, various components of the GSHP 206 and ASHP 204 as shown and described in FIGS. 2-1 and 2-2 have not been explicitly illustrated in FIGS. 2-4 through 2-22.

As mentioned, the ASHP 204 and the GSHP 206 may be included within respective enclosures 201-2 and 201-2. The enclosures may each be a housing, unit, module, casing, or other enclosure within which the various components, systems, etc., of the respective heat pump systems are situated. In some embodiments, one or more components may be considered included in an enclosure when they are positioned on or at the enclosure, such as the downhole coupling 248, facility return inlets, facility supply inlets, (or any other coupling to an associated component or other system) which may be positioned on and/or may penetrate through a respective enclosure.

The GSHP 206 and the ASHP 204 being included within the enclosures 201-1 and 201-2 may facilitate implementing the thermal system 200, for example, as assembled, packaged units at the facility 202. For example, the thermal system 200 may be shipped or otherwise transported to the facility within the enclosures, and the enclosed heat pump systems may be positioned at, near, or on the facility 202. This may facilitate implementing the thermal system 200, for example, by replacing one or more other thermal components, systems, or units, for example, on a roof or in a mechanical room of the facility 202. For instance, existing ductwork of the facility 202 may be re-used by positioning the enclosures in existing spaces or connected to existing holes in a roof or ceiling of the facility 202 (e.g., existing roof curbs). The enclosures 201-1, 201-2, of the thermal system 200 may include any necessary pumps, valves, sensors, controllers, processors, etc. incorporated at, on, or within the enclosures for operating the thermal system 200 as described herein. In this way, the thermal system 200 may be transported to the facility, positioned in its desired location(s), and various circulation systems (e.g., facility fluid, ambient air, downhole fluid) may simply be connected to the associated enclosure for a plug-and-play-type implementation to provide one or more (or all) thermal needs of the facility.

In some cases, the GSHP 206 may be connected to a first roof curb 216-1 of the facility 202 and the ASHP 204 may be connected to a second roof curb 216-2 of the facility 202. The roof curbs (collectively 216) may be structural openings in (e.g., a roof of) the facility 202 which may support roof mounted equipment and which may also provide access to a ductwork or other HVAC components of the facility 202 for flowing a facility fluid 210 to and from the facility 202. The first roof curb 216-1 and the second roof curb 216-2 may serve the same or different spaces within the facility.

In some cases, the enclosures 201-1 and 201-2 may be connected to the roof curbs 216 via a first intermediate manifold 217-1 and a second intermediate manifold 217-2, respectively. For example, the first intermediate manifold 217-1 and the second intermediate manifold 217-2 may each be positioned between the respective enclosure and roof curb. For example, the roof curbs 216 may be existing and/or conventional roof curbs of the facility 202 which may be associated with an existing and/or conventional ductwork system of the facility 202, and the intermediate manifolds 217-1 and 217-2 may facilitate connecting the enclosures 201-1 and 201-2 and/or providing one or more of the components, features, and/or functionalities as described herein. In some cases, the enclosures 201-1 and 201-2 of the GSHP 206 and the ASHP 204 may be directly connected to the roof curbs 216 (e.g., without an intermediate manifold), and the components shown and described as pertaining to the intermediate manifolds 217-1 and 217-2 may, instead, be included and/or incorporated within the respective enclosure 201-1 and 201-2 of the GSHP 206 and the ASHP 204.

As described herein, the thermal system 200 may receive a return facility fluid 210R of the facility fluid 210 to one or both of the GSHP 206 and the ASHP 204 (e.g., via the roof curbs 216), and may provide a supply facility fluid 210S of the facility fluid 210 to the facility 202 (e.g., via the roof curbs 216) as thermally conditioned by one or both of the GSHP 206 and the ASHP 204. For instance, the supply facility fluid 210S may be representative of all of the facility fluid 210 that is supplied to the facility 202 by the thermal system 200 cumulatively, for example, from one or both of the GSHP 206 and the ASHP 204 (e.g., and/or through one or both roof curbs 216). Similarly, the return facility fluid 210R may be representative of all of the facility fluid 210 returned from the facility 202 to the thermal system 200 cumulative, for example, to one or both of the GSHP 206 and the ASHP 204 (e.g., and/or through one or both roof curbs 216).

With reference to FIG. 2-4, in some embodiments, the GSHP 206 implements a first facility fluid circuit 218-1. The first facility fluid circuit 218-1 may be one or more flow paths along which the facility fluid 210 may flow in connection with the GSHP 206. For example, the first facility fluid circuit, 218-1 may include one or more flow paths of the facility fluid 210 (e.g., some of the return facility fluid 210R) which may pass through the first facility heat exchanger 220-1 and by which the facility fluid 210 may be thermally conditioned by the first facility heat exchanger 220-1. For example, a first return flow 222-1 of the facility fluid 210 (e.g., of the return facility fluid 210R) may flow along the first facility fluid circuit 218-1. The first return flow 222-1 may be a portion of the return facility fluid 210R that may flow through a first facility return inlet 224-1 associated with the GSHP 206. For example, the first facility return inlet 224-1 may be an opening, passage, plenum, damper, or other path through which the first return flow 222-1 may flow in order to arrive at the first facility heat exchanger 220-1. The first facility return inlet 224-1 may be positioned within the first intermediate manifold 217-1, or the first enclosure 201-1. In some cases, the GSHP 206 includes a first return pump 226-1, such as a fan, which may direct, pump, or flow the return facility fluid 210R (e.g., the first return flow 222-1). In some cases, the GSHP 206 is implemented without the first return pump 226-1. For example, the flow of the facility fluid along the first facility fluid circuit 218-1 may be achieved by a first supply pump 227-1.

In some embodiments the first return flow 222-1 flows to the first facility heat exchanger 220-1 where it is thermally conditioned to generate a first supply flow 223-1. In some cases, the first supply flow 223-1 flows back to the facility 202 through a first facility supply inlet 225-1. The first facility supply inlet 225-1 may be an opening, passage, plenum, damper, or other path through which the first supply flow 223-1 may flow from the first facility heat exchanger 220-1 and/or to the facility 202. The first facility supply inlet 225-1 may be positioned in the first enclosure 201-1, in the first intermediate manifold 216-1, or otherwise positioned in ductwork within the facility 202. For example, the first facility supply inlet 225-1 may be positioned in a room, space, or area which the thermal system 200 may serve. In some cases, the facility supply inlet 225-1 may be representative of several facility supply inlets 225-1. The first facility supply inlet 225-1 may include or may be associated with a damper which may be operated to control or meter the flow of the facility fluid 210 therethrough. For example, as described herein, in some cases the first supply flow 223-1 and/or a second supply flow 223-2 may flow through the first facility supply inlet 225-1, which flow may be metered or selectively controlled by a damper or other flow control device.

In some cases, the GSHP 206 includes a first supply pump 227-1, such as a fan, which may direct, pump, or flow the first supply flow 223-1 along the first facility fluid circuit 218-1. Thus, in some cases, the first facility fluid circuit 218-1 may include a flow path of the facility fluid 210 that proceeds from the facility 202, through the first facility return inlet 224-1 (e.g., as the first return flow 222-1), through the first facility heat exchanger 220-1, and back to the facility (e.g., as the first supply flow 223-1) through the first facility supply inlet 225-1.

In some cases, the GSHP 206 includes a first air outlet 228-1 for flowing an exhaust flow 210E of the facility fluid 210 out of the facility 202. For instance, a portion of the return facility fluid 210R may exhaust to an ambient environment as the exhaust flow 210E, and a portion (e.g., the remainder) may flow to the first facility heat exchanger 220-1 as the first return flow 222-1. The first air outlet 228-1 may facilitate supplementing some of the facility fluid 210 with new air such as fresh or outside air. For example, the GSHP 206 may include a first air inlet 229-1 through which an inlet flow 210I of the facility fluid 210 may flow. In this way, both the inlet flow 210I and the first supply flow 223-1, in some cases, may flow along the first facility fluid circuit 218-1 to the first facility heat exchanger 220-1.

In some cases, the ASHP 204 may be implemented in much the same way as the GSHP 206. For instance, the ASHP 204 may include any corresponding components for one or more (or all) of the features just described with respect to the GSHP 206. The ASHP 204 may implement a second facility fluid circuit 218-2 as one or more flow paths along which the facility fluid 210 may flow in connection with the ASHP 204. The facility fluid 210 may pass through the second facility heat exchanger 220-2 where it may be thermally conditioned. For example, a second return flow 222-2 of the facility fluid (e.g., of the return facility fluid 210R) may flow along the second facility fluid circuit 218-2 which may be a portion of the return facility fluid 210R that may flow through a second facility return inlet 224-2 associated with the ASHP 204. The second facility return inlet 224-2 may be positioned within the second intermediate manifold 216-2 or within the second enclosure 201-2. In some cases, the ASHP 204 includes a second return pump 226-2.

In some embodiments, the second return flow 222-2 flows to the second facility heat exchanger 220-2 where it is thermally conditioned to generate a second supply flow 223-2. In some cases, the second supply flow 223-2 flows back to the facility 202 through a second facility supply inlet 225-2, which may be positioned within the second intermediate manifold 216-1 or within the second enclosure 201-2. The second facility supply inlet 225-2 may include or may be associated with a damper which may be operated to control or meter the flow of the facility fluid 210 therethrough. For example, as described herein, in some cases the first supply flow 223-1 and/or a second supply flow 223-2 may flow through the second facility supply inlet 225-2, which flow may be metered or selectively controlled by a damper or other flow control device. In some cases, the ASHP 204 includes a second supply pump 227-2. Thus, in some cases, the second facility fluid circuit 218-2 may include a flow path of the facility fluid 210 that proceeds from the facility 202, through the second facility return inlet 224-2 (e.g., as the second return flow 222-2), through the second facility heat exchanger 220-2, and back to the facility (e.g., as the second supply flow 223-2) through the second supply inlet 225-1. In some cases, the ASHP 204 includes a second air outlet 228-2 for exhausting an exhaust flow 210E of the facility fluid 210 out of the facility. The ASHP 204 may also include a second air inlet 229-2 for supplementing an inlet flow 210I of fresh air to the facility fluid 210.

Accordingly, the thermal system 200 includes both the ASHP 204 and the GSHP 206. The thermal system 200 may implement either, or both of, the ASHP 204 or the GSHP 206 to provide thermal conditioning of the facility fluid 210. For example, if the ambient air 232 has more favorable conditions (e.g., more advantageous or efficient operating temperatures) at a specific time for a given operating mode than the geological formation, the thermal system 200 may implement the ASHP 204 to condition the facility fluid 210 (e.g., or more heavily utilize the ASHP 204). In some embodiments, if the geological formation has more favorable conditions (e.g., more advantageous or efficient operating temperatures) at another specific time for a given operating mode than the ambient air 232, the thermal system 200 may implement the GSHP 206 to condition the facility fluid 210 (e.g., or more heavily utilize the GSHP 206). In some cases, both the GSHP 206 and the ASHP 204 may be implemented to condition the facility fluid 210, for example, in parallel. For instance, if a thermal load of the facility exceeds the thermal conditioning capacity of one heat pump, the other may be implemented to supplement. In some cases, a mix of the two heat pumps may be implemented at various levels or percentages. When operated together, the ASHP 204 and the GSHP 206 may generally be operated in the same operating mode (e.g., heating or cooling) in order to work in tandem to condition the facility fluid 210.

In some cases, the thermal system 200 includes a mutual supply duct 270. The mutual supply duct 270 may connect the first facility fluid circuit 218-1 and the second facility fluid circuit 218-2. For example, the mutual supply duct 270 may connect to the enclosures 201-1, 201-2 and/or to the intermediate manifolds 217-1, 217-2 at or near the first and second facility supply inlets 225-1, 225-2. For instance, the mutual supply duct 270 may be positioned on and/or may connect to the first facility fluid circuit 218-1 between the first facility heat exchanger 220-1 and the first facility supply inlet 225-1. The mutual supply duct 270 may be similarly positioned with respect to the second facility fluid circuit 218-2. In this way, output flow paths of the ASHP 204 and the GSHP 206 may be fluidly connected to facilitate various configurations of the thermal system 200, such as to enable the first supply flow 223-1 to flow to the second facility supply inlet 225-2 and/or the second supply flow 223-2 to flow to the first facility supply inlet 225-1 as described herein. In some cases, the mutual supply duct 270 includes a mutual supply damper 271 which may be a flow control device to direct, prevent, meter, or otherwise control the flow of the first supply flow 223-1 and/or the second supply flow 223-2 therethrough. In some cases, the mutual supply damper 271 may be included in addition to or as an alternative to the first facility supply inlet 225-1 and/or the second facility supply inlet 225-2. For example, in some case the first facility supply inlet 225-1 and/or the second facility supply inlet 225-2 may be positioned in ductwork throughout the facility 202 and may not necessarily be located near or adjacent the first enclosure 201-1 or second enclosure 201-2. Accordingly, the mutual supply damper 271 may facilitate directing and/or controlling the flow of the facility fluid throughout the thermal system 200, for example, in accordance with the various operating modes described herein. In some cases, the GSHP 206 may include a first backflow damper 273-1 and the ASHP 204 may include a second backflow damper 273-2, which may be actuatable and/or unidirectional flow control devices to prevent the flow of the facility fluid backward through the respective facility fluid circuits.

In this way, both (and in some cases, one or the other) of the ASHP 204 and the GSHP 206 may be implemented to exchange heat with the facility fluid 210 and provide thermal conditioning to the facility. The thermal system 200 may include various sensors (e.g., temperature, pressure, flowrate, etc.) for monitoring and managing the operation of the thermal system 200. For example, the thermal system 200 may monitor temperatures at one or more of the ambient air 232, the borehole heat exchanger 246 (e.g., inlet and/or outlet temperatures), the geological formation (e.g., one or more ground locations), various locations along the ASHP fluid circuit 234, various locations along the GSHP fluid circuit 244, the facility fluid 210, the facility 202, the downhole fluid circuit 250, any of the mutual ducts as described herein, or any other relevant temperature. Based on one or more of these temperatures (e.g., based on an identified thermal load of the facility 202), the thermal system 200 may operate one or more of the ASHP 204 or the GSHP 206, each at a specified thermal power level, flow rate, etc., to provide the thermal load of the facility. For example, the ASHP 204 and the GSHP 206 may be operated at different flowrates (e.g., the first supply flow 223-1 and the second supply flow 223-2 may have different flowrates) such that the ASHP 204 and the GSHP 206 provide or produce different amounts of thermal conditioning.

FIG. 2-5 illustrates an example embodiment of a thermal system 200-1. The thermal system 200-1 may be substantially similar to the thermal system 200, and may include any of the features and/or functionalities described herein with respect to the thermal system 200. As shown in FIG. 2-5, the thermal system 200-1 may be implemented without the first return pump 226-1 and the second return pump 226-2 as described in connection with the thermal system 200. For example, the return facility fluid may be drawn into the ASHP 204 and/or the GSHP 106 entirely by the first supply pump 227-1 and/or the second supply pump 227-2. In this way, the flow of the facility fluid through the first fluid circuit 218-1 and/or the second fluid circuit 218-2 may be controlled and/or achieved entirely by operation of the supply fans, facility supply inlets, dampers, etc. (e.g., without use of return fans).

FIGS. 2-6 through 2-23 illustrate various operating modes of the thermal system 200, according to at least one embodiment of the present disclosure. For example, FIGS. 2-6 through 2-14 may illustrate various manners in which the thermal system 200 provides the supply facility fluid 210S by one or both of the ASHP 204 and the GSHP 206, and through one or both of the first facility supply inlet 225-1 and the second facility supply inlet 225-2. FIGS. 2-16 through 2-23 may illustrate various manners in which the return facility fluid 210R is received by the thermal system 200 with one or more of the GSHP 206 and the ASHP 204, and through one or more of the first facility return inlet 224-1 and the second facility return inlet 224-2. The various operating modes as illustrated by FIGS. 2-6 through 2-14 may be combinable in any suitable manner for both illustrating the various ways in which the thermal system 200 may receive the return facility fluid 210R from the facility 202 and may provide the supply facility fluid 210S to the facility 202. These operating modes are merely exemplary, and other or alternative operating modes may also be contemplated.

In some embodiments, the thermal system 200 may be configured and operated in the various operating modes in order to provide increased energy efficiency. For example, as described in detail below, in some cases, the GSHP 206 or the ASHP 204 may be operated solely to the exclusion of the other, or else with a higher thermal power than the other. For example, in some cases the GSHP 206 or the ASHP 204 may operate at a higher energy efficiency than the other. For instance, given specific environmental conditions, such as temperatures of the ambient air, geological formation, etc., one heat pump source may be more favorable for providing heating and/or cooling than the other. Accordingly, in some cases the thermal system 200 may be operated solely based on the more favorable heat pump source. In some cases, the other (e.g., less favorable) heat pump may be implemented to provide supplementary thermal conditioning in addition to the primary (e.g., more favorable) heat pump, such as in cases where the thermal load of the facility 202 exceeds the thermal capacity of the prioritized heat pump. For instance, in many cases, the GSHP 206 may be more energy efficient based advantages associated with the geological formation as a thermal source. Accordingly, in many cases the GSHP 206 may be operated with higher priority, for example, to provide all of the thermal conditioning to the facility 202 where possible, with the ASHP 204 supplementing as needed. The opposite may be true in some cases where the ASHP 204 may be more energy efficient, such as in cases where the ambient temperature is closer to a comfort temperature of the facility than that of the geological formation. In this way, the thermal system 200 may utilized the more efficient heat pump to the extent possible to maximize efficiency gains, and may supplement as needed with the less efficient heat pump in situations as needed.

In some cases, the thermal system 200 may selectively operate the thermal powers of the GSHP 206 and the ASHP 204 in order to limit or throttle the thermal power of the GSHP 206. For example, as described, the GSHP 206 operates based on exchanging heat with a geological formation via a borehole heat exchanger. This energy exchange, when taken over a longer period (e.g., a summer or winter season) may cause the temperature of the geological formation to change (e.g., to rise in the summer and to fall in the winter). In many cases, ground-source heat pump systems may be regulated such that ground temperatures of the geological formation must be maintained within certain regulatory thresholds. For instance, regulatory ground temperatures may be implemented to prevent a ground-source heat pump from freezing the ground. Accordingly, in some cases, the thermal system 200 monitors the ground temperature, including forecasting and/or predicting the future ground temperature based on the operation of the GSHP 206 and the thermal needs of the facility 202, and the thermal system 200 may accordingly limit or even stop the use of the GSHP 206 as needed so as not to exceed a regulatory temperature threshold. In this way, the thermal system 200 may be advantageous in that the ASHP 204 may be implemented or more heavily utilized in such situations in order to maintain thermal conditioning of the facility at a desired comfort level (e.g., despite the ASHP 204 being less energy efficient in some situations).

These advantages of the thermal system 200 may be realized through the various operating modes described herein. For example, the GSHP 206, the ASHP 204, or both may be implemented at the same or different thermal power in order to provide conditioned, supply facility fluid 210S to the facility through the first facility supply inlet 225-1, the second facility supply inlet 225-2, or both.

With reference to FIG. 2-6, in some embodiments, the facility fluid 210 is thermally conditioned based on the GSHP 206 alone. For example, the return facility fluid 210R may flow to the first facility fluid circuit 218-1, through the first facility heat exchanger 220-1, and back to the facility 202. The ASHP 204 may be turned off, inactive, and/or may otherwise not operate on any of the facility fluid 210. In some cases, the mutual return supply 271 and/or the second facility supply inlet 225-2 may be closed. In this way, the facility fluid 210 may wholly flow through the GSHP 206, and the facility 202 may be thermally conditioned wholly by the first supply flow 223-1 flowing through the first facility supply inlet 225-1.

In FIG. 2-7, in some cases, the GSHP 206 may be solely implemented to receive and thermally condition the return facility fluid 210R, and the first supply flow 223-1 may flow to the facility through both the first facility supply inlet 225-1 and the second facility supply inlet 225-2 based on a portion of the first supply flow 223-1 flowing through the mutual return duct. The thermal system 200 may be configured in this way based on actuating and/or modulating one or more of the first facility supply inlet 225-1, the second facility supply inlet 225-1, or the mutual supply damper 271. In this way, the GSHP 206 may provide thermal conditioning to the facility 202 through two (or more) different facility supply inlets, such as to two different (and/or isolated) spaces in the facility. As shown in FIG. 2-8, the GSHP 206 may be operated to provide the first supply flow 223-1 through only the second facility supply inlet 225-2 based on the first supply flow 223-1 flowing through the mutual supply duct 270.

In a similar manner to the thermal system solely operating the GSHP 206, in FIG. 2-9 through 2-11, the thermal system may solely operate the ASHP 204. For example, the ASHP 204 may receive and thermally condition the return facility fluid 210R and may provide the second supply flow to the second facility supply inlet 225-2 (FIG. 2-8), to the first facility supply inlet 225-1 (FIG. 2-10) or both (FIG. 2-9). The thermal system 200 may operate in these manners based solely on the GSHP 206 or the ASHP 204 in situations where one heat pump source has more favorable conditions (e.g., temperature) than the other, and where the selected heat pump has the thermal capacity to cover the thermal needs of the facility 202 alone. In this way, either heat pump may be operated as a single rooftop unit to provide thermal conditioning, and, based on the mutual return duct 272, may provide supply facility fluid through any of the facility supply inlets as needed, including through a facility supply inlet (e.g., a roof curb) to which it is not directly connected or associated. For instance, in some cases, the first facility supply inlet 225-1 and the second facility supply inlet 225-2 may serve separate and/or isolated spaced within the facility 202.

With reference to FIG. 2-12, in some embodiments, both the ASHP 204 and the GSHP 206 may be implemented to provide thermal conditioning to the facility 202 in parallel. In some cases, no fluid flow may occur and/or mix between the GSHP 206 and the ASHP 204 via the mutual supply duct 270. For example, the mutual supply damper 271 may be closed.

In some embodiments, the thermal power and/or flow rate of the GSHP 206 and the ASHP 204 may be the same or different, for example, in order to provide the same or different thermal conditioning by each heat pump. For example, based on better operating conditions (temperatures) of one heat pump, that heat pump may be prioritized to provide more thermal conditioning, for example, to increase energy efficiency. In some cases, the supply facility fluid 210S provided through the first facility supply inlet 225-1 and through the second facility supply inlet 225-2 may by supplied to the same space within the facility 202, or in some cases each may serve a different space within the facility 202. In this way, both the GSHP 206 and the ASHP 204 may be operated to thermally condition the facility 202 without implementing the mutual return duct 272 facilitating the mixing of the supply flows of each heat pump.

With reference to FIG. 2-13, in some cases both the ASHP 204 and the GSHP 206 may be implemented to provide thermal conditioning to the facility 202, and the supply flows of the two heat pumps may be mixed and/or combined (at least somewhat) via the mutual supply duct 270. For example, in this particular example, the GSHP 206 may be operated at a higher thermal power to provide more thermal conditioning via the GSHP 206. For example, the first supply flow 223-1 may be at a higher flowrate than the second supply flow 223-2. Based on modulating (e.g., a damper of) the first facility supply inlet 225-1 and the second facility supply inlet 225-2, a portion of the first supply flow 223-1 may flow to the facility 202 via the first facility supply inlet 225-1 and an additional portion may flow through the mutual supply duct 270. That additional portion of the first supply flow 223-1, together with the second supply flow 223-2, may flow to the facility 202 through the second facility supply inlet 225-2. In some cases, this same affect may be achieved additionally or alternatively through a modulation and/or metering by the mutual supply damper 271. In this way, the supply facility fluid 210S may be provided to the facility 202, with a larger portion being provided by the GSHP 206. For example, in some cases the GSHP 206 may be operated at a threshold thermal capacity (e.g., maximum capacity or throttled capacity based on ground temperature considerations), and the ASHP 204 may be additionally operated to supplement the GSHP 206 to meet a thermal load of the facility 202, which thermal load may be greater than the threshold thermal capacity of the GSHP 206.

In a similar way, the thermal system 200 may be operated in an opposite configuration, for example, in which the ASHP 204 is given priority. For example, as shown in FIG. 2-14, both the ASHP 204 and the GSHP 206 may be implemented to provide thermal conditioning to the facility 202, and the supply flows of the two heat pumps may be mixed and/or combined (at least somewhat) via the mutual supply duct 270. In this case, the ASHP 204 may be operated at a higher thermal power to provide more thermal conditioning via the ASHP 204. For example, the second supply flow 223-2 may be at a higher flowrate than the first supply flow 223-1. Based on modulating (e.g., a damper of) the first facility supply inlet 225-1 and the second facility supply inlet 225-2 (e.g., or additionally or alternatively modulating the mutual supply damper 271), a portion of the second supply flow 223-2 may be metered to flow to the facility via the second facility supply inlet 225-2, and an additional portion may flow through the mutual supply duct 270. That additional portion of the second supply flow 223-2, together with the first supply flow 223-1, may flow to the facility 202 through the first facility supply inlet 225-2. In this way, the supply facility fluid 210S may be provided to the facility 202, with a larger portion being provided by the ASHP 204. For example, in some cases, the ASHP 204 may be operated at a threshold capacity (e.g., a maximum capacity), and the GSHP 206 may be additionally operated to supplement the GSHP 206 to meet a thermal load of the facility 202, which thermal load may be greater than the threshold capacity of the ASHP 204.

FIG. 2-15 illustrates a schematic diagram of a thermal system 200-2, according to at least one embodiment of the present disclosure. The thermal system 200-2 may be substantially similar to the thermal system 200, but may include a mutual return duct 272. In some cases, the thermal system 200-2 may include one or more of the features of the thermal system 200-1 as described in connection with FIG. 2-5. For example, as shown, the thermal system 200-2 may not be implemented with one or more return pumps, but rather, the flow of the facility fluid to and through the thermal system 200-2 may be entirely driven by the first supply pump 227-1 and/or the second supply pump 227-2.

The mutual return duct 272 may be a duct that connects the first facility fluid circuit 218-1 and the second facility fluid circuit 218-2. For example, the mutual return duct 272 may connect to and/or may be positioned on the first facility fluid circuit 218-1 between the first facility return inlet 224-1 and the first facility heat exchanger 220-1, and the mutual return duct 272 may connect to and/or may be positioned on the second facility fluid circuit 218-2 between the second facility return inlet 224-2 and the second facility heat exchanger 220-2. For example, the mutual return duct 272 may connect in this manner at the enclosures 201-1, 201-2, at the intermediate manifolds 217-1, 217-2, or otherwise through ductwork of the facility 202. In some cases, the mutual return duct 272 may be positioned outside of the facility, such as at or on a roof of the facility. For instance, the GSHP 206 and the ASHP 204 may be implemented as rooftop units, and the mutual return duct 272 may be ductwork on the roof of the facility 202 connecting the rooftop units. In this way, the mutual return duct 272 may be configured such that some of the first return flow 222-1 and/or some of the second return flow 222-2 may flow through the mutual return duct 272, for example, from one facility fluid circuit to the other.

In some embodiments, the mutual return duct 272 includes a mutual return damper 273. The mutual return damper 273 may be a flow control device which may control, direct, prevent, and/or meter the flow of the first return flow 222-1 and/or the second return flow 222-2 therethrough. In this way, a measured and/or metered amount of the first return flow 222-1 or the second return flow 222-2 may flow through the mutual return duct 272 in order that the thermal system 200-2 may proportion and/or tailor the flowrates, return flows, supply flows, etc. of the GSHP 206 and/or the ASHP 204. In some cases, the mutual return duct 272 may be positioned within the facility.

FIGS. 2-15 through 2-22 illustrate various operating modes of the thermal system 200-2 for providing supply facility fluid to the GSHP 206, the ASHP 204, or both, including implementing the mutual return duct 272 in some cases. The exemplary operating modes of FIGS. 2-15 through 2-22 which illustrate return flows of the facility fluid may be combined in any suitable manner with the operating modes of FIGS. 2-5 through 2-14, which illustrate supply flows of the facility fluid.

As shown in FIG. 2-15, in some cases, the return facility fluid 210R may be provided to the GSHP 206 through the first facility return inlet 224-1. For example, the return facility fluid 210R may consist entirely of the first return flow 222-1, which may flow to the first facility heat exchanger 220-1 where it may be thermally conditioned by the GSHP 206 and may flow back to the facility in one or more of the manners described herein. As shown in FIG. 2-16, the GSHP 206 may alternatively receive the return facility fluid 210R through the second facility return inlet 224-2 and via the mutual return duct 272.

As shown in FIG. 2-17, in some cases, the GSHP 206 may receive the return facility fluid 210R through both the first facility return inlet 224-1 and through the second facility return inlet 224-2. For example, based on actuating the mutual return damper 273, the second return flow 222-2 may flow through the mutual return duct 272 to the first facility fluid circuit 218-1. Together with the first return flow 222-1, the second return flow 222-2 may flow to the first facility heat exchanger 220-1 wherein it may be thermally conditioned and may flow back to the facility in any of the manners described herein.

In similar manner, the thermal system 200-2 may be operated in the opposite way with the ASHP 204 having priority. For example, the ASHP 204 may receive the supply facility fluid 210S from the second facility return inlet 224-2 (FIG. 2-18), the first facility return inlet (2-19), or from both (2-20) based on the mutual return duct 272.

In this way, the facility fluid 210 may be thermally conditioned solely by the GSHP 206 or the ASHP 204, and the return facility fluid may flow from the facility through the first facility return inlet 224-1, the second facility return inlet 224-2, or both. This may facilitate the GSHP 206 or the ASHP 204 operating as a single rooftop unit (e.g., connected to a single roof curb) but servicing multiple (e.g., isolated) spaces throughout the facility based on exchanging facility fluid through various different facility return inlets based on the mutual return duct 272.

As shown in FIG. 2-21, in some cases both the ASHP 204 and the GSHP 206 may be operated to provide thermal conditioning to the facility 202. For example, a portion of the second return flow 222-2 may flow to the second facility heat exchanger 220-2 where it may be thermally conditioned and may flow to the facility 202 in any of the manners described herein. An additional portion of the second return flow 222-2 may flow through the mutual return duct 272 and, together with the first return flow 222-1, may flow to the first facility heat exchanger 220-1. Accordingly, the thermal system may operate both the GSHP 206 in a prioritized capacity and the ASHP 204 in a supplementary capacity, and the return facility fluid 210R may be received through both the first facility return inlet 224-1 and the second facility return inlet 224-2 (e.g., from separate spaces of the facility 202). In this way, the GSHP 206 may operate with a higher flowrate to provide a larger portion of the thermal conditioning. Similarly, as shown in FIG. 2-22, the thermal system 200-2 may be operated with the ASHP 104 primarily providing the thermal conditioning and the GSHP 106 being supplementary.

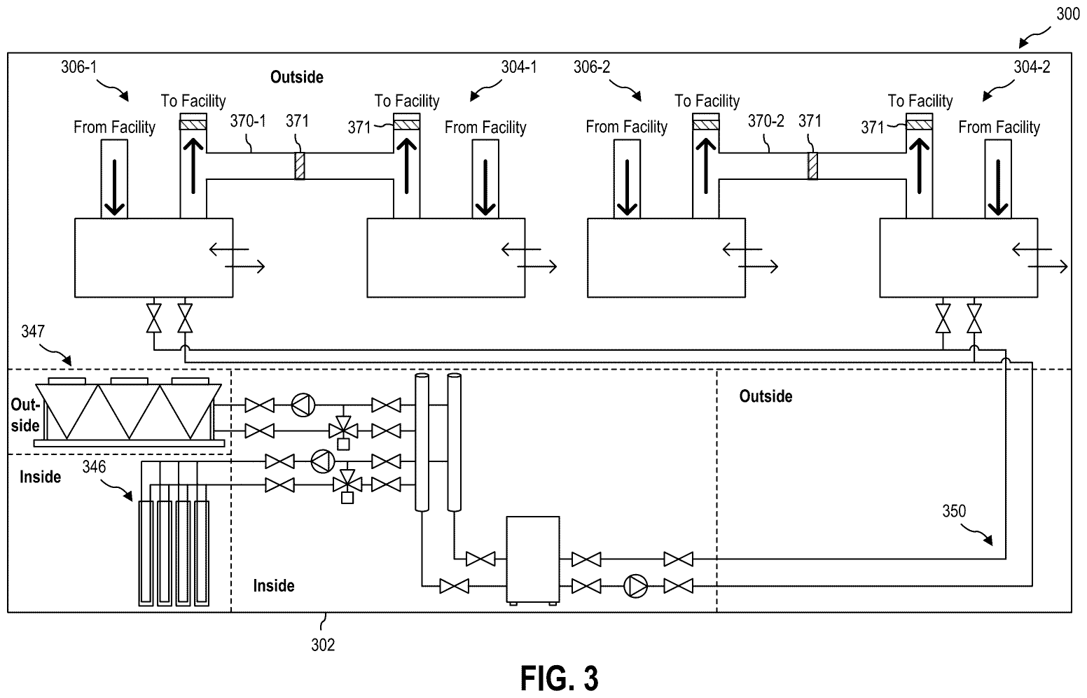

FIG. 3 illustrates a schematic diagram of a thermal system 300 for providing thermal conditioning to a facility 302, according to at least one embodiment of the present disclosure. The thermal system 300 may include any of the features and/or functionalities of the various thermal systems described herein. For example, the thermal system 300 may include a first GSHP 306-1 and a first ASHP 304-1 connected by a first mutual supply duct 370-1. The thermal system 300 may include a second GSHP 306-2 and a second ASHP 304-2 connected by a second mutual supply duct 370-2. The thermal system 300 may be configured, via a variety of dampers 371, to operate in accordance with any of the techniques described herein. In this way, the thermal system 300 may be representative of the scalability of the techniques described herein. For example, each of the heat pumps may be implemented as separate, enclosed roof top units connected at respective roof curbs. Rather than specifically only servicing one interior space as conventional rooftop units, the connection therebetween with the mutual return ducts may facilitate one heat pump source providing thermal conditioning selectively to several different interior spaces based on the mutual return duct. Additionally, both heat pump sources may be utilized together to service the multiple interior spaces through the mutual return ducts. In some cases, both the first GSHP 306-1 and the second GSHP 306-2 may be connected to the same downhole fluid circuit 350, which may include a borehole heat exchanger 346, a dry cooler 347, or both.

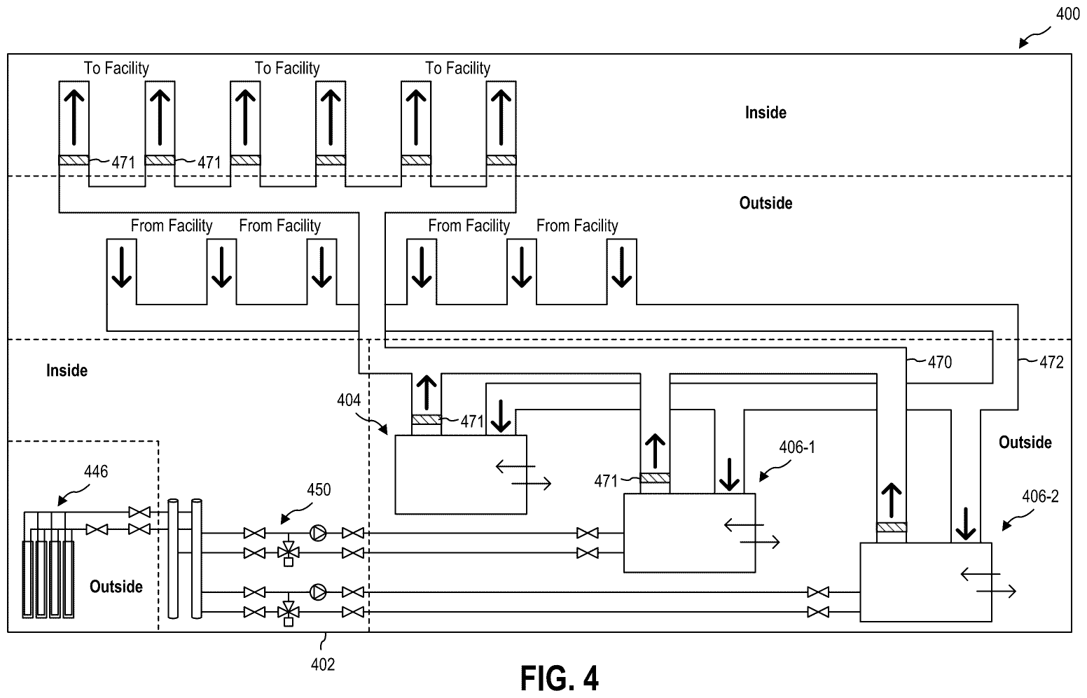

FIG. 4 illustrates a schematic diagram of a thermal system 400, according to at least one embodiment of the present disclosure. The thermal system 400 represents an example of how the techniques described herein can be scaled with GSHPs and/or ASHPs connected and proportioned in quantities that are not necessarily equal and/or 1:1. For example, the thermal system 400 includes an ASHP 404, a first GSHP 406-1 and a second GSHP 406-2. The first GSHP 406-1 and the second GSHP 406-2 may be connected to the same downhole fluid circuit 450 (e.g., including a borehole heat exchanger 446).

The thermal system 400 includes a mutual supply duct 470 which may be connected to each of the ASHP 404, the first GSHP 406-1 and the second GSHP 406-2. The thermal system 400 may include a mutual return duct 472 which may be connected to each of the ASHP 404, the first GSHP 406-1 and the second GSHP 406-2. Various dampers 471 may be positioned throughout the thermal system 400, including within the mutual supply duct 470 and/or the mutual return duct 472 to configure the thermal system 400 to operate in accordance with the techniques described herein. In this way, any (or multiple) of the heat pumps may be operated as environmental conditions permit (for increased efficiency) and may provide thermal conditioning to various spaces within a facility 402 based on the mutual supply duct 470 and/or the mutual return duct 472.

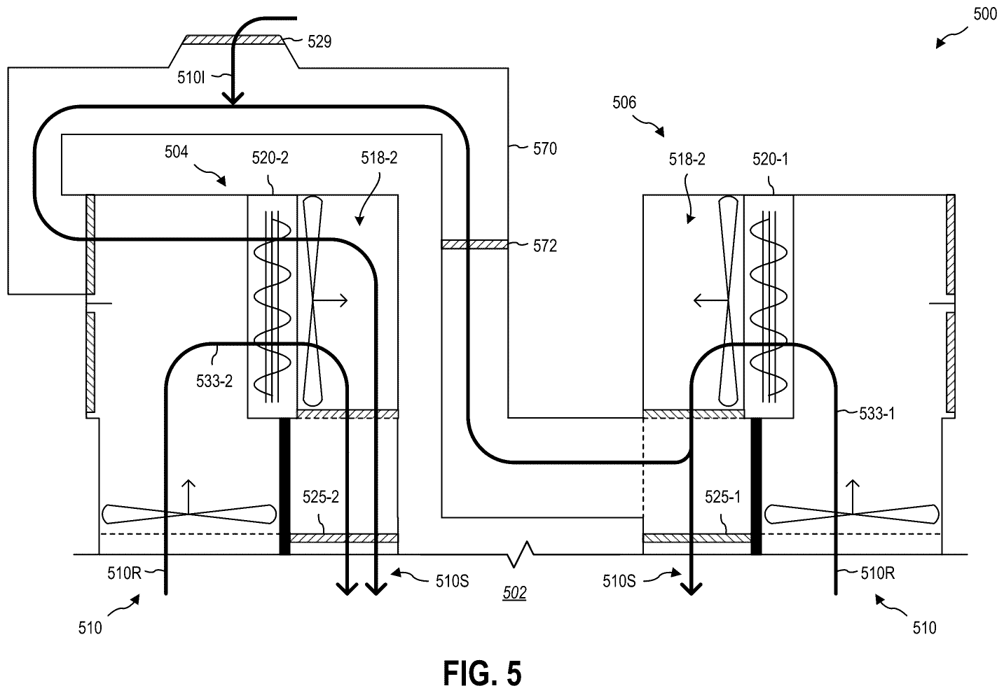

FIG. 5 illustrates a schematic diagram of a thermal system 500 for providing thermal conditioning to a facility 502, according to at least one embodiment of the present disclosure. The thermal system 500 includes a GSHP 506 and an ASHP 504. The GSHP 506 may be substantially similar to the GSHPs described herein, such as in connection with FIGS. 2-1 and 2-4. For example, the GSHP 506 may implement a first facility fluid circuit 518-1 by which a first supply flow 533-1 may be generated based on thermal conditioning by a first facility heat exchanger 520-1. The ASHP 504 may be substantially similar to the ASHPs described herein, such as in connection with FIGS. 2-3 and 2-4. For example, the ASHP 504 may implement a second facility fluid circuit 518-2 by which a second supply flow 533-2 may be generated based on thermal conditioning by a second facility heat exchanger 520-2.

The thermal system 500 includes a mutual duct 570, which may connect to an outlet of the GSHP 506 and to an inlet of the ASHP 504 such that the GSHP 506 and the ASHP 504 are connected in series. For instance, the GSHP 506 may be connected upstream of the ASHP 504. The mutual duct 570 may connect to the first facility fluid circuit between the first facility supply inlet 525-1 and the first facility heat exchanger 520-1. The mutual duct 570 may connect to the second facility fluid circuit 518-2 at a point on the second facility fluid circuit 518-2 that is upstream of the second facility heat exchanger 520-2. For example, the thermal system 500 may be configured such that the GSHP 506 receives and thermally conditions return facility fluid 210R and generates a first supply flow 533-1. In some cases, the thermal system 500 directs the first supply flow 533-1 to the facility through a first facility supply inlet 525-1 and in this way the facility 502 (e.g., or a first space of the facility 502) may receive thermal conditioning. In some cases, based on actuating a damper 572, the thermal system 500 may direct some of the first supply flow 533-1 through the mutual duct 570 and through a second facility supply inlet 525-2. For example, the first supply flow 533-1 may flow entirely to the second facility supply inlet 525-2, or the first supply flow 533-1 may flow partly to the first facility supply inlet 525-2 and partly to the second facility supply inlet 525-2. In some cases, the ASHP 504 may be turned off such that it provides no thermal conditioning, and in this way, the GSHP 506 may solely be operated to thermally condition the facility 502 through the first facility supply inlet 525-1, the second facility supply inlet 525-2, or both.

In some embodiments, both the GSHP 506 and the ASHP 504 may be operated to provide thermal conditioning. For example, the GSHP 506 may operate in a primary capacity and the ASHP 504 may provide supplemental thermal conditioning. For example, the portion of the first supply flow 533-1 (e.g., some or all of the first supply flow 533-1 that, in some cases, flows through the mutual duct 570 may be further thermally conditioned by the ASHP 504, after which it may flow to the facility through the second facility supply inlet 525-2. This may facilitate meeting a thermal load of the facility, for example, in situations where the GSHP 506 cannot sufficiently condition the first supply flow 533-1 to meet the thermal load. In some cases, the mutual duct 570 includes an air inlet 529, which may facilitate drawing in an inlet flow 5101 of the facility fluid, which may be fresh air or outside air. The air inlet 529 on the mutual duct 570 may connect the GSHP 506 and the ASHP 504 in the serial manner described. For example, in some cases, the mutual duct 570 may connect to what otherwise would be an air inlet of the ASHP 504, and the air inlet 529 on the mutual duct 570 may provide a means for supplementing the facility fluid 510 with fresh or outside air.

In some cases, the ASHP 504 receives return facility fluid 510R, for example, in addition to receiving the first supply flow 533-1. The ASHP 504 may accordingly thermally condition both the return facility fluid 510R to generate a second supply flow 533-2, as well as further conditioning the first supply flow 533-1. Both the first supply flow 533-1 and the second supply flow 533-2 may accordingly flow to the facility through the second facility supply inlet 525-2. In this way, the thermal system 500 may be configured in series such that the GSHP 506 may be implemented for primary thermal conditioning, and the ASHP 504 may be provide supplemental thermal conditioning as needed, and the supply flows produced by the thermal system 500 may flow to the facility through the first facility supply inlet 525-1, the second facility supply inlet 525-2, or both. The serial configuration in this way may provide simplicity to the thermal systems and the mutual ducting techniques described herein, and may be specifically applicable to situations in which the GSHP 506 is generally (or always) implemented in a primary role to provide the thermal conditioning, with the ASHP 504 serving as a supplement.

### INDUSTRIAL APPLICABILITY

The following description from section A1 to section I18 includes various embodiments that, where feasible, may be combined in any permutation. For example, the embodiment of section A1 may be combined with any or all embodiments of the following sections. Embodiments that describe acts of a method may be combined with embodiments that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”
A1. A thermal system for a facility, comprising:
   a first facility fluid circuit, including:
      a facility fluid for circulating in the facility to provide thermal conditioning of the facility as a supply facility fluid;
      a first facility heat exchanger for exchanging heat with the facility fluid to generate a first supply flow of the supply facility fluid; and
      a first facility supply inlet for providing the supply facility fluid to the facility;
   a second facility fluid circuit, including:
      the facility fluid;
      a second facility heat exchanger for exchanging heat with the facility fluid to generate a second supply flow of the supply facility fluid; and
      a second facility supply inlet for providing the supply facility fluid to the facility;
   a ground-source heat pump thermally connected to the first facility fluid circuit, including:
      a ground-source heat pump fluid circuit;
      a ground-source heat exchanger positioned on the ground-source heat pump fluid circuit and configured to exchange heat with a downhole fluid;
      the first facility heat exchanger for exchanging heat with the facility fluid; and
      a ground-source working fluid for circulating through the ground-source heat pump fluid circuit to exchange heat with the facility fluid at the first facility heat exchanger, and to exchange heat with the downhole fluid of a downhole fluid circuit at the ground-source heat exchanger;
   an air-source heat pump thermally connected to the second facility fluid circuit, including:
      an air-source heat pump fluid circuit;
      an air-source heat exchanger positioned on the air-source heat pump fluid circuit and configured to exchange heat with an ambient air;
      the second facility heat exchanger positioned on the air-source heat pump fluid circuit; and
      an air-source working fluid for circulating through the air-source heat pump fluid circuit to exchange heat with the facility fluid at the second facility heat exchanger, and to exchange heat with the ambient air at the air-source heat exchanger; and
   a control system for controlling both the ground-source heat pump and the air-source heat pump to thermally condition the facility based on circulating the facility fluid through one or more of the first facility fluid circuit or the second facility fluid circuit.
A2. The thermal system of A1 further comprising a mutual supply duct connecting the first facility fluid circuit and the second facility fluid circuit, wherein the mutual supply duct connects to the first facility fluid circuit between the first facility heat exchanger and the first facility supply inlet, and the mutual supply duct connects to the second facility fluid circuit between the second facility heat exchanger and the second facility supply inlet.
A3. The thermal system of A2, further configured to operate in a plurality of operating modes, including:
   a first operating mode, wherein the ground-source heat pump and the air-source heat pump each provide thermal conditioning to the facility in parallel and wherein the supply facility fluid of the facility fluid comprises at least some of the first supply flow and at least some of the second supply flow; and
   a second operating mode, wherein the air-source heat pump is turned off and the ground-source heat pump provides thermal conditioning to the facility and wherein the supply facility fluid consists of the first supply flow flowing to the facility through at least one of the first facility supply inlet or the second facility supply inlet.
A4. The thermal system of A3, wherein in the first operating mode, at least some of the first supply flow flows to the facility through the first facility supply inlet and through the second facility supply inlet.
A5. The thermal system of A3 or A4, wherein in the first operating mode, at least some of the second supply flow flows to the facility through the first facility supply inlet and through the second facility supply inlet.
A6. The thermal system of A4 or A5, wherein in the first operating mode, the ground-source heat pump and the air-source heat pump provide different amounts of thermal conditioning to the facility based on the first supply flow and the second supply flow having different flowrates.
A7. The thermal system of any of A3-A6, further configured to operate in a third operating mode, wherein the ground-source heat pump is turned off and the air-source heat pump provides thermal conditioning to the facility and wherein the supply facility fluid consists of the second supply flow flowing to the facility through at least one of the first facility supply inlet and the second facility supply inlet.
A8. The thermal system of any of A2-A7, wherein the first facility supply inlet includes a first supply damper for metering the supply facility fluid therethrough and the second facility supply inlet includes a second supply damper for metering the supply facility fluid therethrough.
A9. The thermal system of any of A2-A8, further comprising a mutual supply damper in the mutual supply duct configured to meter the flow of the first supply flow from the first facility fluid circuit to the second facility supply inlet, and configured to meter the flow of the second supply flow from the second facility fluid circuit to the first facility supply inlet.
A10. The thermal system of any of A2-A9, wherein the first facility supply inlet provides the supply facility fluid to a first space of the facility and the second facility supply inlet provides the supply facility fluid to a second space of the facility.
A11. The thermal system of any of A2-A10, wherein the first facility fluid circuit further comprises a first backflow damper to prevent backflow of the facility fluid through the first facility fluid circuit, and the second facility fluid circuit comprises a second backflow damper to prevent backflow of the facility fluid through the second facility fluid circuit.
A12. The thermal system of any of A2-A11, wherein the first facility fluid circuit includes a first supply pump for pumping the first supply flow through the first facility heat exchanger, and the second facility fluid circuit includes a second supply pump for pumping the second supply flow through the second facility heat exchanger.
A13. The thermal system of any of A2-A12, wherein the first facility fluid circuit includes a first return pump for pumping a first return flow of the facility fluid from the facility and the second facility fluid circuit includes a second return pump for pumping a second return flow of the facility fluid from the facility.
A14. The thermal system of any of A2-A13, wherein the first facility fluid circuit includes a first air inlet for providing a first inlet flow of air to the facility fluid, and the second facility fluid circuit includes a second air inlet for providing a second inlet flow of air to the facility fluid.
A15. The thermal system of claim 2, wherein the first facility fluid circuit includes a first air outlet for exhausting a first exhaust flow of the facility fluid, and the second facility fluid circuit includes a second air outlet for exhausting a second exhaust flow of the facility fluid.
A16. The thermal system of any of A2-A15, wherein the ground-source heat pump and the air-source heat pump each includes one or more compressors and one or more expansion valves for exchanging heat based on performing mechanical work on the ground-source working fluid and the air-source working fluid, respectively, and wherein the ground-source heat pump and the air-source heat pump are each reversible heat pumps for transferring heat to and from the facility fluid.
A17. The thermal system of any of A2-A16, further comprising:
   one or more fluid distribution devices included on the ground-source heat pump fluid circuit for directing the ground-source working fluid between the ground-source heat exchanger and the first facility heat exchanger;
   one or more fluid distribution devices included on the air-source heat pump fluid circuit for directing the air-source working fluid between the air-source heat exchanger and the second facility heat exchanger; and
   a controller for controlling an operation of the thermal system based on:
      controlling the one or more fluid distribution devices of the ground-source heat pump fluid circuit to control the generation of the first supply flow;
      controlling the flow rate of the first supply flow;
      controlling the one or more fluid distribution devices of the air-source heat pump fluid circuit to control the generation of the second supply flow; and
      controlling the flowrate of the second supply flow.
A18. The thermal system of any of A2-A18, further comprising:
   one or more sensors for measuring one or more of:
      a temperature at one or more locations of the facility;
      a temperature of the facility fluid at one or more locations of the first facility fluid circuit;
      a temperature of the facility fluid at one or more location of the second facility fluid circuit;
      a temperature of the ambient air;
      a temperature of the air-source working fluid at one or more locations of the air-source heat pump fluid circuit;
      a temperature of a geological formation of the downhole fluid circuit;
      a temperature of the downhole fluid at one or more locations of the downhole fluid circuit; or
      a temperature of the ground-source working fluid at one or more locations of the ground-source heat pump fluid circuit;
   one or more fluid distribution devices including one or more valves for configuring the ground-source heat pump and the air-source heat pump into a plurality of operating modes of the thermal system to provide one or more of heating or cooling to the facility with one or more of the air-source heat pump or the ground-source heat pump;
   one or more dampers for configuring the first facility fluid circuit and the second facility fluid circuit into the plurality of operating modes of the thermal system; and
   a controller for controlling the one or more fluid distribution devices and the one or more dampers to configure the plurality of operating modes of the thermal system based on one or more measurements from the one or more sensors.
A19. The thermal system of any of A2-A18, wherein:
   the first facility fluid circuit includes a first facility return inlet for providing a first return flow of the facility fluid from the facility;
   the second facility fluid circuit includes a second facility return inlet for providing a second return flow of the facility fluid from the facility; and
   the thermal system further comprises a mutual return duct connecting the first facility fluid circuit and the second facility fluid circuit, wherein the mutual return duct connects to the first facility fluid circuit between the first facility return inlet and the first facility heat exchanger, and the mutual return duct connects to the second facility fluid circuit between the second facility return inlet and the second facility heat exchanger.
A20. The thermal system of any 19, further configured to operate in a plurality of operating modes, including:
   a first operating mode, wherein the ground-source heat pump and the air-source heat pump each provide thermal conditioning to the facility in parallel, wherein the second supply flow is generated based on second return flow from the second facility return inlet, and wherein the first supply flow is generated based on the first return flow from the first facility return inlet and based on at least some of the second return flow flowing through the mutual return duct to the first facility heat exchanger, and
   a second operating mode, wherein the air-source heat pump is turned off and the ground-source heat pump provides thermal conditioning to the facility, and wherein the first supply flow is generated based on the first return flow the second return flow flowing through the mutual return duct to the first facility heat exchanger.
A21. The thermal system of A20, further configured to operate in a third operating mode wherein the ground-source heat pump is turned off and the air-source heat pump provides thermal conditioning to the facility, and wherein the second supply flow is generated based on the second return flow from the second facility return inlet and based on the first return flow from the first facility return inlet flowing through the mutual return duct to the second facility heat exchanger.
A22. The thermal system of any of A19-A21, further comprising a return damper in the mutual return duct configured to meter the flow of the first return flow from the first facility return inlet to the second facility heat exchanger and configured to meter the flow of the second return flow from the second facility return inlet to the first facility heat exchanger.
A23. The thermal system of any of A19-A22, further comprising:
   a first enclosure, including:
      the first facility heat exchanger; and
      the ground-source heat pump; and
   a second enclosure, including:
      the second facility heat exchanger; and
      the air-source heat pump;
   wherein:
   the first facility supply inlet is fluidly connected to the first enclosure for providing the supply facility fluid to the facility;
   the second facility supply inlet is fluidly connected to the second enclosure for providing the supply facility fluid to the facility; and
   the mutual supply duct is connected to the first enclosure and the second enclosure to fluidly connect the first enclosure to the second facility supply inlet and to connect the second enclosure to the first facility supply inlet.
B1. A thermal system for connecting to a facility for providing thermal conditioning to the facility based on exchanging heat with a facility fluid of the facility, the thermal system comprising:
   a first enclosure, including:
      a first facility heat exchanger positioned within the first enclosure for exchanging heat with the facility fluid to generate a first supply flow of a supply facility fluid;
      a ground-source heat pump positioned within the first enclosure, including:
         a ground-source heat pump fluid circuit;
         a ground-source heat exchanger positioned on the ground-source heat pump fluid circuit and configured to exchange heat with a downhole fluid of a downhole fluid circuit;
         the first facility heat exchanger positioned on the ground-source heat pump fluid circuit; and
         a ground-source working fluid for circulating through the ground-source heat pump fluid circuit to exchange heat with the facility fluid at the first facility heat exchanger, and to exchange heat with the downhole fluid at the ground-source heat exchanger;
   a second enclosure, including:
      a second facility heat exchanger positioned within the second enclosure for exchanging heat with the facility fluid to generate a second supply flow of the supply facility fluid;
      an air-source heat pump positioned within the second enclosure, including:
         an air-source heat pump fluid circuit;
         an air-source heat exchanger positioned on the air-source heat pump fluid circuit and configured to exchanger heat with an ambient air;
         the second facility heat exchanger positioned on the air-source heat pump fluid circuit; and
         an air-source working fluid for circulating through the air-source heat pump fluid circuit to exchange heat with the facility fluid at the second facility heat exchanger, and to exchange heat with the ambient air at the air-source heat exchanger;
   a first facility supply inlet fluidly connected to the first enclosure for providing the supply facility fluid to the facility;
   a second facility supply inlet fluidly connected to the second enclosure for providing the supply facility fluid to the facility; and
   a mutual supply duct connected to the first enclosure and the second enclosure to fluidly connect the first enclosure to the second facility supply inlet and to connect the second enclosure to the first facility supply inlet.
B2. The thermal system of B1, wherein the first enclosure and the second enclosure are positioned on a roof of the facility.
B3. The thermal system of B1 or B2, wherein the first enclosure is connected to a first roof curb of the facility for exchanging the facility fluid with the facility and the second enclosure is connected to a second roof curb of the facility for exchanging the facility fluid with the facility.
B4. The thermal system of any of B1-B3, wherein the mutual supply duct is positioned outside of the facility.
B5. The thermal system of any of B1-B4, wherein the first facility supply inlet is included in the first enclosure and the second facility supply inlet is included in the second enclosure.
B6. The thermal system of any of B1-B5, wherein:
   the first enclosure is connected to the first roof curb by a first intermediate manifold positioned between the first enclosure and the first roof curb;
   the second enclosure is connected to the second roof curb by a second intermediate manifold positioned between the second enclosure and the second roof curb;
   the first facility supply inlet is including in the first intermediate manifold;
   the second facility supply inlet is included in the second intermediate manifold; and
   the mutual supply duct is connected to the first intermediate manifold and the second intermediate manifold.
B7. The thermal system of any of B1-B6 further comprising:
   a first facility return inlet fluidly connected to the first enclosure for providing a return facility fluid to the first enclosure;
   a second facility return inlet fluidly connected to the second enclosure for providing the return facility fluid to the second enclosure; and
   a mutual return duct connected to the first enclosure and the second enclosure to fluidly connect the first facility return inlet to the second enclosure and to connect the second facility return inlet to the first enclosure.
C1. A thermal system for a facility, comprising:
   a first facility fluid circuit, including:
      a facility fluid for circulating in the facility to provide thermal conditioning of the facility as a supply facility fluid;
      a first facility heat exchanger for exchanging heat with the facility fluid to generate a first supply flow of the supply facility fluid; and
      a first facility supply inlet for providing the supply facility fluid to the facility;
   a second facility fluid circuit, including:
      the facility fluid;
      a second facility heat exchanger for exchanging heat with the facility fluid to generate a second supply flow of the supply facility fluid; and
      a second facility supply inlet for providing the supply facility fluid to the facility;
   a ground-source heat pump thermally connected to the first facility fluid circuit, including:
      a ground-source heat pump fluid circuit;
      a ground-source heat exchanger positioned on the ground-source heat pump fluid circuit and configured to exchange heat with a downhole fluid;
      the first facility heat exchanger for exchanging heat with the facility fluid; and
      a ground-source working fluid for circulating through the ground-source heat pump fluid circuit to exchange heat with the facility fluid at the first facility heat exchanger, and to exchange heat with the downhole fluid of a downhole fluid circuit at the ground-source heat exchanger;
   an air-source heat pump thermally connected to the second facility fluid circuit, including:
      an air-source heat pump fluid circuit;
      an air-source heat exchanger positioned on the air-source heat pump fluid circuit and configured to exchange heat with an ambient air;
      the second facility heat exchanger positioned on the air-source heat pump fluid circuit; and
      an air-source working fluid for circulating through the air-source heat pump fluid circuit to exchange heat with the facility fluid at the second facility heat exchanger, and to exchange heat with the ambient air at the air-source heat exchanger; and
   a mutual duct connecting the first facility fluid circuit and the second facility fluid circuit, wherein the mutual duct connects to the first facility fluid circuit between the first facility heat exchanger and the first facility supply inlet, and the mutual duct connects to the second facility fluid circuit upstream of the second facility heat exchanger.
C2. The thermal system of C1, wherein the mutual duct connects the ground-source heat pump and the air-source heat pump in series.
C3. The thermal system of C1 or C2, wherein the first supply flow is configured to flow through the mutual duct and to be further thermally condition at the second facility heat exchanger of the air-source heat pump.
D1. A heating and cooling system for a building including:
   a building fluid circuit for circulating a building fluid in the building, configured to heat and/or cool the building;
   a heat pump system including:
      at least a working fluid circuit for circulating a working fluid and comprising a compressor system;
      at least a first heat exchanger, wherein the at least one first heat exchanger is configured to exchange heat between the or at least one of the working fluid circuit and at least a source circuit; and
      a second heat exchanger configured to exchange heat between the or at least one of the working fluid circuit and the building fluid circuit,
   two source circuits including:
      a downhole fluid circuit for circulating a downhole fluid between the or at least one of the first heat exchanger of the heat pump system and a borehole heat exchanger situated in a geological formation; and
      an air circulation circuit for circulating air in the or at least one of the first heat exchanger of the heat pump system,
   Wherein the system is configured so that heat is transferred from the downhole fluid and from air to the building fluid.
D2. The system of D1, wherein the heat pump system includes:
   a working fluid circuit, and
   one first heat exchanger configured to exchange heat between the downhole fluid circuit, the air circulation circuit and the working fluid circuit.
D3. The system of D1 or D2, wherein the heat pump system includes:
   a first working fluid circuit; and
   a second working fluid circuit;
   wherein the at least one first heat exchanger includes:
      a ground source heat exchanger for exchanging heat between the downhole fluid circuit and the first working fluid circuit; and
      an air heat exchanger for exchanging heat between the air circulation circuit and the second working fluid circuit,
   wherein the second heat exchanger to exchange heat between the first and second working fluid circuits and the building fluid circuit.
D4. The system of any of D1-D3, wherein each working fluid circuit includes a fluid circulation device movable between a first position enabling a first mode of operation in which the working fluid extracts heat from at least one of the source circuit through the at least one first heat exchanger and a second position enabling a second mode of operation in which the working fluid extracts heat from the building fluid through the second heat exchanger.
D5. The system of D3 or D4, configured so that the fluid circulation devices of the first and second working fluid circuit so that the first and second working fluid circuits are in the same mode of operation.
D6 The system of any of D1-D5, including one or more sensors to measure parameters of the building and/or of the external environment and/or of the building fluid and/or of the downhole fluid and/or of the at least one working fluids, and a processor to control the system as a function of one or more of the measured parameters.
D7. The system of any of D1-D6, wherein the building fluid is air, and wherein the system includes an air inlet connected to the external environment for entering renewed air in the building,
D8. The system of D7, including an air outlet connected to the external environment for exiting used air from the building and a heat exchanger between the air inlet and the air outlet.
D9. The system of D7 or D8, including at least an air damper in the air inlet and/or outlet and a regulating motor to control the air dampers.
D10. The system of D9, including one or more sensors to measure parameters of the building and/or of the external environment and/or of the building fluid and/or of the downhole fluid and/or of the at least one working fluids and at least one processor to control the regulating motor as a function of one or more measured parameters.
D11. The system of any of D7-D10, including at least a freecooling/freeheating heat exchanger configured to exchange heat between the renewed air and or used air and the downhole fluid circulating in the downhole fluid circuit.
D12. The system of D11, wherein the downhole fluid circuit including a downhole fluid circulating device to allow or prevent the circulation of the downhole fluid in the at least one freecooling/freeheating heat exchanger.
D13. The system of D11, including one or more sensors to measure parameters of the building and/or of the external environment and/or of the building fluid and/or of the downhole fluid and at least one processor to control downhole fluid circulating device as a function of one or more measured parameters.
D14. The system of any of D1-D13, further comprising a hot water supply circuit, and a hot water heat exchanger to exchange heat between the hot water supply circuit and at least one of the working fluid circuits.
D15. The system of any of D1-D14, further comprising a cold fluid supply circuit and a cold fluid heat exchanger to exchange heat between the downhole fluid circuit and the cold fluid circuit.
D16. The system of any of the D1-D15 claim, further comprising a second building fluid circuit to heat and/or cool the building and a second building fluid heat exchanger to exchange heat between the second building fluid circuit and the at least one working fluid circuit.
D17. The system of any od D1-D14, including a unit including:
   the heat pump system;
   the air circulation circuit;
   a downhole fluid circuit having inlet and outlet connected to the borehole heat exchanger, and optionally one or more fluid circulation devices;
   a building fluid circuit having a building fluid inlet and outlet connected to the building, wherein the building fluid circuit outlet is optionally associated with an air damper;
   optionally the air inlet, optionally associated with an air damper;
   optionally the air outlet, optionally associated with an air damper;
   optionally the regulating motor for regulating the air dampers;
   optionally the freecooling/freeheating heat exchanger;
   optionally the hot water supply inlet and outlet and the hot water heat exchanger;
   optionally the cold fluid supply inlet and outlet and a cold fluid heat exchanger;
   optionally a second building fluid circuit inlet and outlet and the second building fluid heat exchanger;
   optionally the one or more sensors to measure parameters of the building and/or of the external environment and/or of the building fluid and/or of the downhole fluid and/or of the at least one working fluids; and
   optionally at least one processor to control one or more devices of the system as a function of the one or more measured parameters.
E1. A heating and cooling unit for a building including:
   a building fluid circuit having a building fluid inlet and outlet to connect the heating and cooling unit to the building fluid supply circuit configured to heat and/or cool the building;
   a heat pump system including:
      at least a working fluid circuit for circulating a working fluid, comprising a compressor system;
      at least a first heat exchanger, wherein the at least one first heat exchanger is configured to exchange heat between the or at least one of the working fluid circuit and at least a source circuit; and
      a second heat exchanger configured to exchange heat between the or at least one of the working fluid circuit and the building fluid circuit,
   an air circulation circuit for circulating air in the or at least one of the first heat exchanger of the heat pump system; and
   a downhole fluid circuit for circulating a downhole fluid having a downhole fluid circuit inlet and outlet for connecting the unit to a borehole heat exchanger situated in a geological formation, wherein the downhole fluid circuit is configured to connect the borehole heat exchanger to the at least one first heat exchanger,
   wherein the unit is configured so that heat is transferred from the downhole fluid and from air to the building fluid.
E2. The unit of claim E1, wherein it is situated on the roof or inside of the building.
E3. The unit of claim E1 or E2, wherein the heat pump system includes a working fluid circuit; and
   one first heat exchanger configured to exchange heat between the downhole fluid circuit, the air circulation circuit and the working fluid circuit.
E4. The unit of claim any of E1-E3, wherein the heat pump system includes
   a first working fluid circuit;
   and a second working fluid circuit;
   wherein the at least one first heat exchanger includes:
      a ground source heat exchanger for exchanging heat between the downhole fluid circuit and the first working fluid circuit; and
      an air heat exchanger for exchanging heat between the air circulation circuit and the second working fluid circuit,
   wherein the second heat exchanger to exchange heat between the first and second working fluid circuits and the building fluid circuit.
E5. The unit of any of E1-E4, wherein each working fluid circuit includes a fluid circulation device movable between a first position enabling a first mode of operation in which the working fluid extracts heat from at least one of the source circuit through the at least one first heat exchanger and a second position enabling a second mode of operation in which the working fluid extracts heat from the building fluid through the second heat exchanger.
E6. The unit of E4 or E5, configured so that the fluid circulation devices of the first and second working fluid circuit so that the first and second working fluid circuits are in the same mode of operation.
E7. The unit of any of E1-E6, including one or more sensors to measure parameters of the building and/or of the external environment and/or of the building fluid and/or of the downhole fluid and/or of the at least one working fluids, and a processor to control the system as a function of one or more of the measured parameters.
E8. The unit of any of E1-E7, wherein the building fluid is air, and wherein the unit includes an air inlet connected to the external environment for entering renewed air in the building,
E9. The unit of claim E8, including an air outlet connected to the external environment for exiting used air from the building and a heat exchanger between the building fluid inlet and the building fluid outlet.
E10. The unit of E8 or E9, including at least an air damper in the air inlet and/or outlet and a regulating motor to control the air dampers.
E11. The unit of the preceding claim, including one or more sensors to measure parameters of the building and/or of the external environment and/or of the building fluid and/or of the downhole fluid and/or of the at least one working fluids and at least one processor to control the regulating motor as a function of one or more measured parameters.
E12. The unit of claim E8-E11, including at least a freecooling/freeheating heat exchanger configured to exchange heat between the renewed air and or used air and the downhole fluid circulating in the downhole fluid circuit.
E13. The unit of E12, wherein the downhole fluid circuit including a downhole fluid circulating device to allow or prevent the circulation of the downhole fluid in the at least one freecooling/freeheating heat exchanger.
E14. The unit of E13, including one or more sensors to measure parameters of the building and/or of the external environment and/or of the building fluid and/or of the downhole fluid and at least one processor to control downhole fluid circulating device as a function of one or more measured parameters.
E15. The unit of any of E1-E14, further comprising a hot water circuit having a hot water inlet and outlet to connect to a hot water supply circuit of the building, and a hot water heat exchanger to exchange heat between the hot water circuit and at least one of the working fluid circuits.
E16. The unit of any of E1-E15, further comprising a cold fluid circuit having a cold fluid inlet and outlet to connect to a cold fluid supply circuit of the building and a cold water heat exchanger to exchange heat between the downhole fluid circuit and the cold water circuit.
E17. The unit of any of E1-E16, further comprising a second building fluid circuit having a second building fluid inlet and outlet to connect to a second building fluid supply circuit of the building and configured to heat and/or cool the building, and a second building fluid heat exchanger to exchange heat between the second building fluid unit circuit and the at least one working fluid circuit.
F1. A system as disclosed in the present disclosure.
G1 A unit as disclosed in the present disclosure.
H1. A method for operating the system and/or unit as disclosed in the present disclosure.
I1. A heating and cooling system for a building including:
   a building fluid circuit for circulating a building fluid in the building, configured to heat and/or cool the building;
   a ground source heat pump system including:
      a first working fluid circuit for circulating a working fluid and comprising a compressor system;
      a first ground source heat exchanger, configured to exchange heat between the first working fluid circuit and a downhole fluid circuit for circulating a downhole fluid between through a borehole heat exchanger situated in a geological formation; and
      a second ground source heat exchanger configured to exchange heat between the first working fluid circuit and the building fluid circuit;
   an air source heat pump system including:
      a second working fluid circuit for circulating a working fluid and comprising a compressor system;
      a first air source heat exchanger, configured to exchange heat between the second working fluid circuit and an air fluid circuit in fluid communication with air from the outside environment; and
      a second air source heat exchanger configured to exchange heat between the second working fluid circuit and the building fluid circuit,
   wherein the heating and cooling system is configured so that it is able to transfer heat from both the downhole fluid and from air to the building fluid.
I2. The system of I1, wherein at least one of the first and second working fluid circuit includes a fluid circulation device movable between a first position enabling a first mode of operation in which the working fluid extracts heat from the air circulation, respectively downhole fluid circulation system, through the first air source, respectively ground source, heat exchanger and a second position enabling a second mode of operation in which the working fluid extracts heat from the building fluid through the second air source, respectively ground source, heat exchanger.
I3. The system of I2, a controller to control the fluid circulation devices of the first and second working fluid circuit so that the first and second working fluid circuits are in the same mode of operation.
I4. The system of any I1-13, including one or more sensors to measure parameters of the building and/or of the external environment and/or of the building fluid and/or of the downhole fluid and/or of the at least one working fluids, and a processor to control the system as a function of one or more of the measured parameters.
15. The system of I4, wherein the processor controls both the air source heat pump system and the ground source heat pump system.
I6. The system of any of I1-15, wherein the building fluid is air, and wherein the system includes at least an air inlet connected to the external environment for entering renewed air in the building,
I7. The system of I6, including at least an air outlet connected to the external environment for exiting used air from the building and a heat exchanger between the air inlet and the air outlet.
18. The system of any of I6 or I7, including at least an air damper in the air inlet and/or outlet and a regulating motor to control the air dampers.
19. The system of I8, including one or more sensors to measure parameters of the building and/or of the external environment and/or of the building fluid and/or of the downhole fluid and/or of the at least one working fluids and at least one processor to control the regulating motor as a function of one or more measured parameters.
I10. The system of any of I6-I9, including at least a freecooling/freeheating heat exchanger configured to exchange heat between the renewed air and/or used air and the downhole fluid circulating in the downhole fluid circuit.
I11. The system of I10, wherein the downhole fluid circuit including a downhole fluid circulating device to allow or prevent the circulation of the downhole fluid in the at least one freecooling/freeheating heat exchanger.
I12. The system of I10 or I11, including one or more sensors to measure parameters of the building and/or of the external environment and/or of the building fluid and/or of the downhole fluid and at least one processor to control downhole fluid circulating device as a function of one or more measured parameters.
I13. The system of any of any of I1-112, further comprising a hot water supply circuit, and a hot water heat exchanger to exchange heat between the hot water supply circuit and at least one of the first and second working fluid circuits.
I14. The system of any of I1-I13, further comprising a cold fluid supply circuit and a cold fluid heat exchanger to exchange heat between the downhole fluid circuit and the cold fluid circuit.
I15. The system of any of I1-I14, further comprising a second building fluid circuit to heat and/or cool the building and a second building fluid heat exchanger to exchange heat between the second building fluid circuit and at least one of the first and second working fluid circuit.
I16. The system of any of I1-I15, including:
   a first unit including:
      the ground source heat pump system;
      a downhole fluid circuit having inlet and outlet connected to the borehole heat exchanger, and optionally one or more fluid circulation devices; and
      a first building fluid fluid inlet and outlet connected to a building fluid circuit; and
   a second unit including:
      the air source heat pump system;
      the air circulation circuit having inlet and outlet connected to an external environment of the building; and
      a second building fluid fluid inlet and outlet connected to the building fluid circuit.
I17. The system of I16, wherein at least one of the first and second unit is a rooftop unit.
I18. The system of I16 or I17, wherein at least one of the first and second unit includes one or more of:
   the air inlet, optionally associated with an air damper;
   the air outlet, optionally associated with an air damper;
   the regulating motor for regulating the air dampers;
   the freecooling/freeheating heat exchanger connected to the downhole fluid circuit;
   the hot water supply inlet and outlet and the hot water heat exchanger;
   the cold fluid supply inlet and outlet and a cold fluid heat exchanger;
   a second building fluid circuit inlet and outlet and the second building fluid heat exchanger;
   the one or more sensors to measure parameters of the building and/or of the external environment and/or of the building fluid and/or of the downhole fluid and/or of the at least one working fluids; and
   the at least one processor to control the system as a function of the one or more measured parameters.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A thermal system for a facility, comprising:
a first facility fluid circuit, including:
a facility fluid for circulating in the facility to provide thermal conditioning of the facility as a supply facility fluid;
a first facility heat exchanger for exchanging heat with the facility fluid to generate a first supply flow of the supply facility fluid; and
a first facility supply inlet for providing the supply facility fluid to the facility;
a second facility fluid circuit, including:
the facility fluid;
a second facility heat exchanger for exchanging heat with the facility fluid to generate a second supply flow of the supply facility fluid; and
a second facility supply inlet for providing the supply facility fluid to the facility;
a ground-source heat pump thermally connected to the first facility fluid circuit, including:
a ground-source heat pump fluid circuit;
a ground-source heat exchanger positioned on the ground-source heat pump fluid circuit and configured to exchange heat with a downhole fluid;
the first facility heat exchanger for exchanging heat with the facility fluid; and
a ground-source working fluid for circulating through the ground-source heat pump fluid circuit to exchange heat with the facility fluid at the first facility heat exchanger, and to exchange heat with the downhole fluid of a downhole fluid circuit at the ground-source heat exchanger;
an air-source heat pump thermally connected to the second facility fluid circuit, including:
an air-source heat pump fluid circuit;
an air-source heat exchanger positioned on the air-source heat pump fluid circuit and configured to exchange heat with an ambient air;
the second facility heat exchanger positioned on the air-source heat pump fluid circuit; and
an air-source working fluid for circulating through the air-source heat pump fluid circuit to exchange heat with the facility fluid at the second facility heat exchanger, and to exchange heat with the ambient air at the air-source heat exchanger; and
a control system for controlling both the ground-source heat pump and the air-source heat pump to thermally condition the facility based on circulating the facility fluid through one or more of the first facility fluid circuit or the second facility fluid circuit.

2. The thermal system of claim 1 further comprising a mutual supply duct connecting the first facility fluid circuit and the second facility fluid circuit, wherein the mutual supply duct connects to the first facility fluid circuit between the first facility heat exchanger and the first facility supply inlet, and the mutual supply duct connects to the second facility fluid circuit between the second facility heat exchanger and the second facility supply inlet.

3. The thermal system of claim 2, further configured to operate in a plurality of operating modes, including:
a first operating mode, wherein the ground-source heat pump and the air-source heat pump each provide thermal conditioning to the facility in parallel and wherein the supply facility fluid of the facility fluid comprises at least some of the first supply flow and at least some of the second supply flow; and
a second operating mode, wherein the air-source heat pump is turned off and the ground-source heat pump provides thermal conditioning to the facility and wherein the supply facility fluid consists of the first supply flow flowing to the facility through at least one of the first facility supply inlet or the second facility supply inlet.

4. The thermal system of claim 3, wherein in the first operating mode, at least some of the first or of the second supply flow flows to the facility through the first facility supply inlet and through the second facility supply inlet.

5. The thermal system of claim 4, wherein in the first operating mode, the ground-source heat pump and the air-source heat pump provide different amounts of thermal conditioning to the facility based on the first supply flow and the second supply flow having different flowrates.

6. The thermal system of claim 3, further configured to operate in a third operating mode, wherein the ground-source heat pump is turned off and the air-source heat pump provides thermal conditioning to the facility and wherein the supply facility fluid consists of the second supply flow flowing to the facility through at least one of the first facility supply inlet and the second facility supply inlet.

7. The thermal system of claim 2, wherein the first facility supply inlet includes a first supply damper for metering the supply facility fluid therethrough and the second facility supply inlet includes a second supply damper for metering the supply facility fluid therethrough.

8. The thermal system of claim 2, further comprising a mutual supply damper in the mutual supply duct configured to meter the flow of the first supply flow from the first facility fluid circuit to the second facility supply inlet, and configured to meter the flow of the second supply flow from the second facility fluid circuit to the first facility supply inlet.

9. The thermal system of claim 2, wherein the first facility fluid circuit further comprises a first backflow damper to prevent backflow of the facility fluid through the first facility fluid circuit, and the second facility fluid circuit comprises a second backflow damper to prevent backflow of the facility fluid through the second facility fluid circuit.

10. The thermal system of claim 2, wherein the first facility fluid circuit includes a first supply pump for pumping the first supply flow through the first facility heat exchanger, and the second facility fluid circuit includes a second supply pump for pumping the second supply flow through the second facility heat exchanger.

11. The thermal system of claim 2, wherein the first facility fluid circuit includes a first return pump for pumping a first return flow of the facility fluid from the facility and the second facility fluid circuit includes a second return pump for pumping a second return flow of the facility fluid from the facility.

12. The thermal system of claim 2, wherein:
the first facility fluid circuit includes a first air inlet for providing a first inlet flow of air to the facility fluid;
the second facility fluid circuit includes a second air inlet for providing a second inlet flow of air to the facility fluid;
the first facility fluid circuit includes a first air outlet for exhausting a first exhaust flow of the facility fluid; and
the second facility fluid circuit includes a second air outlet for exhausting a second exhaust flow of the facility fluid.

13. The thermal system of claim 2, wherein the ground-source heat pump and the air-source heat pump each includes one or more compressors and one or more expansion valves for exchanging heat based on performing mechanical work on the ground-source working fluid and the air-source working fluid, respectively, and wherein the ground-source heat pump and the air-source heat pump are each reversible heat pumps for transferring heat to and from the facility fluid.

14. The thermal system of claim 2, further comprising:
one or more fluid distribution devices included on the ground-source heat pump fluid circuit for directing the ground-source working fluid between the ground-source heat exchanger and the first facility heat exchanger;
one or more fluid distribution devices included on the air-source heat pump fluid circuit for directing the air-source working fluid between the air-source heat exchanger and the second facility heat exchanger; and
a controller for controlling an operation of the thermal system based on:
controlling the one or more fluid distribution devices of the ground-source heat pump fluid circuit to control the generation of the first supply flow;
controlling the flow rate of the first supply flow;
controlling the one or more fluid distribution devices of the air-source heat pump fluid circuit to control the generation of the second supply flow; and
controlling the flowrate of the second supply flow.

15. The thermal system of claim 2, further comprising:
one or more sensors for measuring one or more of:
a temperature at one or more locations of the facility;
a temperature of the facility fluid at one or more locations of the first facility fluid circuit;
a temperature of the facility fluid at one or more location of the second facility fluid circuit;
a temperature of the ambient air;
a temperature of the air-source working fluid at one or more locations of the air-source heat pump fluid circuit;
a temperature of a geological formation of the downhole fluid circuit;
a temperature of the downhole fluid at one or more locations of the downhole fluid circuit; or
a temperature of the ground-source working fluid at one or more locations of the ground-source heat pump fluid circuit;
one or more fluid distribution devices including one or more valves for configuring the ground-source heat pump and the air-source heat pump into a plurality of operating modes of the thermal system to provide one or more of heating or cooling to the facility with one or more of the air-source heat pump or the ground-source heat pump;
one or more dampers for configuring the first facility fluid circuit and the second facility fluid circuit into the plurality of operating modes of the thermal system; and
a controller for controlling the one or more fluid distribution devices and the one or more dampers to configure the plurality of operating modes of the thermal system based on one or more measurements from the one or more sensors.

16. The thermal system of claim 2, wherein:
the first facility fluid circuit includes a first facility return inlet for providing a first return flow of the facility fluid from the facility;
the second facility fluid circuit includes a second facility return inlet for providing a second return flow of the facility fluid from the facility; and
the thermal system further comprises a mutual return duct connecting the first facility fluid circuit and the second facility fluid circuit, wherein the mutual return duct connects to the first facility fluid circuit between the first facility return inlet and the first facility heat exchanger, and the mutual return duct connects to the second facility fluid circuit between the second facility return inlet and the second facility heat exchanger.

17. The thermal system of claim 16, further configured to operate in a plurality of operating modes, including:
a first operating mode, wherein the ground-source heat pump and the air-source heat pump each provide thermal conditioning to the facility in parallel, wherein the second supply flow is generated based on second return flow from the second facility return inlet, and wherein the first supply flow is generated based on the first return flow from the first facility return inlet and based on at least some of the second return flow flowing through the mutual return duct to the first facility heat exchanger, and
a second operating mode, wherein the air-source heat pump is turned off and the ground-source heat pump provides thermal conditioning to the facility, and wherein the first supply flow is generated based on the first return flow the second return flow flowing through the mutual return duct to the first facility heat exchanger.

18. The thermal system of claim 1, further comprising:
a first enclosure, including:
the first facility heat exchanger; and
the ground-source heat pump; and
a second enclosure, including:
the second facility heat exchanger; and
the air-source heat pump;
wherein:
the first facility supply inlet is fluidly connected to the first enclosure for providing the supply facility fluid to the facility;
the second facility supply inlet is fluidly connected to the second enclosure for providing the supply facility fluid to the facility; and
a mutual supply duct is connected to the first enclosure and the second enclosure to fluidly connect the first enclosure to the second facility supply inlet and to connect the second enclosure to the first facility supply inlet.

19. A thermal system for connecting to a facility for providing thermal conditioning to the facility based on exchanging heat with a facility fluid of the facility, the thermal system comprising:
a first enclosure, including:
a first facility heat exchanger positioned within the first enclosure for exchanging heat with the facility fluid to generate a first supply flow of a supply facility fluid;
a ground-source heat pump positioned within the first enclosure, including:
a ground-source heat pump fluid circuit;
a ground-source heat exchanger positioned on the ground-source heat pump fluid circuit and configured to exchange heat with a downhole fluid of a downhole fluid circuit;
the first facility heat exchanger positioned on the ground-source heat pump fluid circuit; and
a ground-source working fluid for circulating through the ground-source heat pump fluid circuit to exchange heat with the facility fluid at the first facility heat exchanger, and to exchange heat with the downhole fluid at the ground-source heat exchanger;
a second enclosure, including:
a second facility heat exchanger positioned within the second enclosure for exchanging heat with the facility fluid to generate a second supply flow of the supply facility fluid;
an air-source heat pump positioned within the second enclosure, including:
an air-source heat pump fluid circuit;
an air-source heat exchanger positioned on the air-source heat pump fluid circuit and configured to exchanger heat with an ambient air;
the second facility heat exchanger positioned on the air-source heat pump fluid circuit; and
an air-source working fluid for circulating through the air-source heat pump fluid circuit to exchange heat with the facility fluid at the second facility heat exchanger, and to exchange heat with the ambient air at the air-source heat exchanger;
a first facility supply inlet fluidly connected to the first enclosure for providing the supply facility fluid to the facility;
a second facility supply inlet fluidly connected to the second enclosure for providing the supply facility fluid to the facility; and
a mutual supply duct connected to the first enclosure and the second enclosure to fluidly connect the first enclosure to the second facility supply inlet and to connect the second enclosure to the first facility supply inlet.

20. A thermal system for a facility, comprising:
a first facility fluid circuit, including:
a facility fluid for circulating in the facility to provide thermal conditioning of the facility as a supply facility fluid;
a first facility heat exchanger for exchanging heat with the facility fluid to generate a first supply flow of the supply facility fluid; and
a first facility supply inlet for providing the supply facility fluid to the facility;
a second facility fluid circuit, including:
the facility fluid;
a second facility heat exchanger for exchanging heat with the facility fluid to generate a second supply flow of the supply facility fluid; and
a second facility supply inlet for providing the supply facility fluid to the facility;
a ground-source heat pump thermally connected to the first facility fluid circuit, including:
a ground-source heat pump fluid circuit;
a ground-source heat exchanger positioned on the ground-source heat pump fluid circuit and configured to exchange heat with a downhole fluid;
the first facility heat exchanger for exchanging heat with the facility fluid; and
a ground-source working fluid for circulating through the ground-source heat pump fluid circuit to exchange heat with the facility fluid at the first facility heat exchanger, and to exchange heat with the downhole fluid of a downhole fluid circuit at the ground-source heat exchanger;
an air-source heat pump thermally connected to the second facility fluid circuit, including:
an air-source heat pump fluid circuit;
an air-source heat exchanger positioned on the air-source heat pump fluid circuit and configured to exchange heat with an ambient air;
the second facility heat exchanger positioned on the air-source heat pump fluid circuit; and
an air-source working fluid for circulating through the air-source heat pump fluid circuit to exchange heat with the facility fluid at the second facility heat exchanger, and to exchange heat with the ambient air at the air-source heat exchanger; and
a mutual duct connecting the first facility fluid circuit and the second facility fluid circuit, wherein the mutual duct connects to the first facility fluid circuit between the first facility heat exchanger and the first facility supply inlet, and the mutual duct connects to the second facility fluid circuit upstream of the second facility heat exchanger.
